(19) United States
(12) Patent Application Publication
(10) Pub. No.: US 2009/0057954 A1
(43) Pub. Date: Mar. 5, 2009

(54) SOLUTION CASTING METHOD AND APPARATUS

(75) Inventors: Takuro NISHIMURA, Kanagawa (JP); Hidekazu Yamazaki, Kanagawa (JP); Yukihiro Katai, Kanagawa (JP); Takao Taguchi, Shizuoka (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/203,736

(22) Filed: Sep. 3, 2008

(30) Foreign Application Priority Data
Sep. 3, 2007 (JP) 2007-227696

(51) Int. Cl. B29C 39/02; B29C 39/22; B29C 39/38

(52) U.S. Cl. 264/299; 425/404

(57) ABSTRACT

A casting dope is cast onto a moving peripheral surface to form a casting film. The casting film is cooled to be hardened or solidified. The casting film is peeled from the peripheral surface by a peeling roller to form a primary wet film. The primary wet film is transported to a transfer section. The primary wet film is sent from the transfer section to a first drying chamber. Wet gas containing water vapor is applied to the primary wet film in the first drying chamber. Water molecules are absorbed into the primary wet film. The water molecules absorbed into the primary wet film expand meshes of network structure of polymer molecules of the primary wet film. The diffusion of liquid compounds contained in the primary wet film is accelerated. Thus, the elimination of the liquid compounds can be facilitated.

### FIELD OF THE INVENTION

The present invention relates to a solution casting method and a solution casting apparatus.

### BACKGROUND OF THE INVENTION

A polymer film (hereinafter referred to as film) has advantages such as excellent light transmission properties and flexibility, and is easy to be made lighter and thinner. Accordingly, the film is widely used as an optical functional film. As a representative of the film, a triacetyl cellulose (TAC) film using cellulose acylate (especially, triacetyl cellulose (TAC) with an average acetylation degree in the range of 57.5 to 62.5%) has toughness and flame retardancy, and therefore the TAC film is utilized as a film base of photosensitive material. Additionally, since the TAC film has an excellent optical isotropy, the TAC film is utilized as an optical functional film such as a protective film for a polarizing filter, an optical compensation film, and a wideview film as components of a liquid crystal display (LCD) whose market is increasingly expanded recently.

As a film production method, mainly, there are a melt-extrusion method and a solution casting method. In the melt-extrusion method, a polymer is heated to be melted, and then extruded by an extruder, to form a film. The melt-extrusion method has advantages such as high productivity and relatively low equipment cost. However, in the melt-extrusion method, it is difficult to adjust thickness accuracy of the film, and further fine streaks (die lines) easily occur on the film. Accordingly, it is difficult to produce a film having high quality as an optical functional film. On the contrary, in the solution casting film, a polymer solution (hereinafter referred to as a dope) containing a polymer and a solvent is cast onto a support to form a casting film. The casting film is hardened enough to be peelable and have a self-supporting property, and then peeled from the support to form a wet film. The wet film is dried and wound as a film. In the solution casting method, it is possible to obtain a film having more excellent optical isotropy and thickness evenness and containing less foreign substances in comparison with the melt-extrusion method. Therefore, the solution casting method is adopted for a producing method of a film, in particular, an optical functional film (for example, see in Japanese Patent Laid-Open Publication No. 2006-306052).

Recently, in accordance with rapid increase in demand for LCD, a solution casting method having high production efficiency has been desired. In the solution casting method, most time required for producing a film is occupied by a drying process in which residual solvent need to be removed from a casting film, a wet film, and the like. Therefore, for the purpose of increasing production efficiency in the solution casting method, it is proposed to shorten the time required for the drying process.

According to the solution casting method disclosed in Japanese Patent Laid-Open Publication No. 2006-306052, a surface temperature of a wet film is adjusted in accordance with a degree of drying, and thereby a certain effect for shortening the time required for the drying process can be obtained. However, in a case where the thickness of the wet film is increased, in the drying process in which only the surface temperature of the wet film is adjusted, it is difficult to remove the solvent away from the surface of the wet film, namely, the solvent contained deep inside the wet film. As a result, it has been impossible to shorten the drying time. Especially, in a case where the thickness of the wet film exceeds 100 μm, the prolonged drying time leads to a serious problem.

As described above, in order to remove the solvent contained deep inside the wet film, a method for drying the wet film at higher temperature is known. However, when the temperature for the drying process is raised, thermal decomposition of the polymer as a material of the film is induced, and thereby resulting in decrease in the optical properties, mechanical properties, and the like of the film. Accordingly, there is a limit for efficiently producing a film having a thickness equal to or more than a predetermined value based on the solution casting method disclosed in Japanese Patent Laid-Open Publication No. 2006-306052 and other well-known methods.

### SUMMARY OF THE INVENTION

In view of the above, an object of the present invention is to provide a solution casting method and apparatus for producing a film efficiently.

To achieve the above object, according to the present invention, there is provided a solution casting method including the steps of: casting a dope containing a polymer and a solvent onto a support to form a casting film; hardening the casting film on the support; peeling the casting film from the support to form a wet film; and drying the wet film in dry gas to form a film, the dry gas containing a small-volume compound having molar volume smaller than that of a liquid compound constituting the solvent.

It is preferable that, when the solvent consists of plural compounds, among said plural compounds, a compound having the smallest molar volume is the liquid compound. Further, the dry gas preferably contains the small-volume compound having molecular weight in the range of 0.3 MS to 1.0 MS, MS being an amount of saturated water vapor of the small-volume compound in the dry gas. A temperature of the dry gas is preferably at least a boiling point (° C.) of the small-volume compound and at most three times the boiling point (° C.).

Preferably, the liquid compound contains at least one of dichloromethane, methanol, ethanol, and butanol, and the small-volume compound contains at least one of water, methanol, acetone, and methyl ethyl ketone.

It is preferable that the drying is applied to the wet film after drying by a tenter dryer. Further, preferably, heated gas is applied to the wet film after the drying.

According to the present invention, there is provided a solution casting apparatus including: a support onto which a dope containing a polymer and a solvent is cast to form a casting film thereon; and a drying device for drying a wet film in dry gas to form a film, the dry gas containing a small-volume compound having molar volume smaller than that of a liquid compound constituting the solvent, and the wet film being the casting film peeled from the support.

The drying device preferably includes: plural rollers for transporting the wet film, the wet film being bridged over the rollers; a drying chamber for housing the plural rollers; and a dry gas supplying unit for circulating the dry gas in the drying chamber. Further, it is preferable that the solution casting apparatus further includes a tenter dryer disposed in an upstream side from the drying device in a transporting direction of the wet film, the tenter dryer holding side ends of the wet film and transporting the wet film while applying dry gas thereto. Furthermore, it is preferable that the solution casting apparatus further includes a dryer using heated air disposed in a downstream side from the drying device in the transporting direction of the wet film, the dryer using heated air applying heated gas to the wet film transported from the drying device.

According to the solution casting method of the present invention, since the wet film is dried in the dry gas containing the small-volume compounds, the small-volume compounds are absorbed into the wet film. Since the small-volume compounds absorbed into the wet film expand meshes of the network structure of polymer molecules, the liquid compounds remained in the wet film are readily diffused and reach the vicinity of the surface in which drying is more rapidly performed. As a result, it is possible to facilitate the removal of the solvent. Accordingly, according to the present invention, it is possible to achieve improvement in the diffusion of liquid compounds remained in the wet film without performing the drying process at a high temperature. Therefore, it is possible to efficiently produce the film while preventing thermal decomposition of polymer molecules, and the like.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is an explanation view schematically illustrating a dope production line for producing a primary dope according to an embodiment of the present invention;

FIG. 2 is an explanation view schematically illustrating a film production process;

FIG. 3 is an explanation view schematically illustrating a first film production line;

FIG. 4 is an explanation view schematically illustrating a first drying process performed in a first drying chamber;

FIG. 5 is an explanation view schematically illustrating a first wet gas supplying device;

FIG. 6 is an explanation view schematically illustrating processing time required for drying a casting film to form a film and transitional change in residual amount of solvent;

FIG. 7 is an explanation view schematically illustrating a second wet gas supplying device;

FIG. 8 is an explanation view schematically illustrating the first drying process performed in a transfer section; and

FIG. 9 is an explanation view schematically illustrating a main part of a second film production line.

### DESCRIPTION OF THE PREFERRED EMBODIMENTS

Embodiments of the present invention are described hereinbelow. The present invention, however, is not limited to the following embodiments.

(Polymer)

Cellulose acylate is used as a polymer in this embodiment. Especially preferable cellulose acylate is triacetyl cellulose (TAC). In the TAC, it is preferable that the degree of the acyl substitution for hydrogen atoms in hydroxyl groups in cellulose satisfies all of the following formulae (I) to (III):

2.5≦A+B≦3.0 (I)

0≦A≦3.0 (II)

0≦B≦2.9 (III)

In the above formulae (I) to (III), “A” represents a degree of substitution of the hydrogen atom in the hydroxyl group to the acetyl group in cellulose, while “B” represents a degree of substitution of the hydrogen atom in the hydroxyl group to the acyl group with 3 to 22 carbon atoms in cellulose. Preferably, at least 90 wt % of TAC particles has a diameter in the range of 0.1 mm to 4 mm, respectively. Note that, the polymer capable of being used in the present invention is not limited to cellulose acylate. The polymer may be any well-known substance as long as the substance can be dissolved into the solvent and serve as a dope.

Cellulose has glucose units making β-1,4 bond, and each glucose unit has a liberated hydroxyl group at second, third, and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third, and the sixth positions in cellulose (when the whole (100%) of the hydroxyl group at the same position is substituted, the degree of substitution at this position is 1).

The total degree of substitution for the acyl groups, namely DS2+DS3+DS6, is preferably in the range of 2.00 to 3.00, more preferably in the range of 2.22 to 2.90, and most preferably in the range of 2.40 to 2.88. In addition, DS6/(DS2+DS3+DS6) is preferably at least 0.28, more preferably at least 0.30, and most preferably in the range of 0.31 to 0.34. Note that DS2 is the degree of substitution of the hydrogen atom in the hydroxyl group at second position per glucose unit to the acyl group (hereinafter referred to as a degree of acyl substitution at second position), DS3 is the degree of substitution of the hydrogen atom in the hydroxyl group at third position per glucose unit to the acyl group (hereinafter referred to as a degree of acyl substitution at third position), and DS6 is the degree of substitution of the hydrogen atom in the hydroxyl group at sixth position per glucose unit to the acyl group (hereinafter referred to as a degree of acyl substitution at sixth position).

In the present invention, the kind of the acyl groups in cellulose acylate can be one or more. When two or more kinds of acyl groups are in cellulose acylate, it is preferable that one of them is the acetyl group. When a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.22 to 2.90, and more preferably in the range of 2.40 to 2.88. In addition, DSB is preferably at least 0.30, and more preferably at least 0.7. In the DSB, the percentage of the substitution of the hydroxyl group at the sixth position is at least 20%, preferably at least 25%, more preferably at least 30%, and most preferably at least 33%. Furthermore, the value of DSA+DSB, in which the hydroxyl group is at the sixth position in cellulose acylate, is preferably at least 0.75, more preferably at least 0.80, and most preferably at least 0.85. By using such cellulose acylate that satisfies the above conditions, a solution (dope) with excellent solubility can be prepared. Especially, since using a non-chlorine organic solvent enables production of excellent solution, it is possible to produce the dope with low viscosity and excellent filterability.

Cellulose as a material of cellulose acylate may be obtained from either linter or pulp.

According to the present invention, as for cellulose acylate, the acyl group having at least 2 carbon atoms may be either aliphatic group or aryl group, and is not especially limited. As examples of the cellulose acylate, there are alkylcarbonyl ester, alkenylcarbonyl ester, aromatic carbonyl ester, aromatic alkylcarbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphthylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

(Solvent)

As a solvent to be used for preparing the dope, there are aromatic hydrocarbon (for example, benzene, toluene, and the like), halogenated hydrocarbon (for example, dichloromethane, chlorobenzene, and the like), alcohol (for example, methanol, ethanol, n-propanol, n-butanol, diethylene glycol, and the like), ketone (for example, acetone, methylethyl ketone, and the like), ester (for example, methylacetate, ethylacetate, propylacetate, and the like), ether (for example, tetrahydrofuran, methyl cellosolve, and the like), and the like. Note that in the present invention the dope means a polymer solution or dispersion solution that is obtained by dissolving or dispersing the polymer in the solvent.

The halogenated hydrocarbon preferably has 1 to 7 carbon atoms, and is most preferably dichloromethane. In view of physical properties of the TAC, such as solubility, peelability of a casting film from the support, a mechanical strength of the film, and optical properties of the film, it is preferable to use at least one kind of alcohol having 1 to 5 carbon atoms together with dichloromethane. The content of alcohol is preferably in the range of 2 wt % to 25 wt %, and more preferably in the range of 5 wt % to 20 wt % relative to the whole solvent. Applicable alcohols are, for example, methanol, ethanol, n-propanol, iso-propanol, n-butanol, and the like, and especially methanol, ethanol, n-butanol, and a mixture of them are more preferable among them.

Recently, in order to reduce adverse influence on the environment to the minimum, a solvent containing no dichloromethane is proposed. In this case, the solvent preferably contains ether with 4 to 12 carbon atoms, ketone with 3 to 12 carbon atoms, ester with 3 to 12 carbon atoms, and alcohol with 1 to 12 carbon atoms. The solvent also contains a mixture of them. For example, the mixed solvent contains methylacetate, acetone, ethanol, and n-butanol. Note that ether, ketone, ester, and alcohol may have a cyclic structure. A compound having at least two functional groups thereof (that is, —O—, —CO—, —COO—, and —OH) may be used as the solvent. The solvent may contain other functional groups such as alcoholic hydroxyl groups.

Details regarding cellulose acylate are described in paragraphs [0140] to [0195] in Japanese Patent Laid-Open Publication No. 2005-104148. The description is also applicable to the present invention. Further, details regarding the solvents and the additives (such as a plasticizer, a deterioration inhibitor, a UV-absorbing agent, an optical anisotropy controller, a retardation controller, dye, a matting agent, a release agent, a release improver, and the like) are also described in paragraphs [0196] to [0516] in the same publication.

(Dope Production Method)

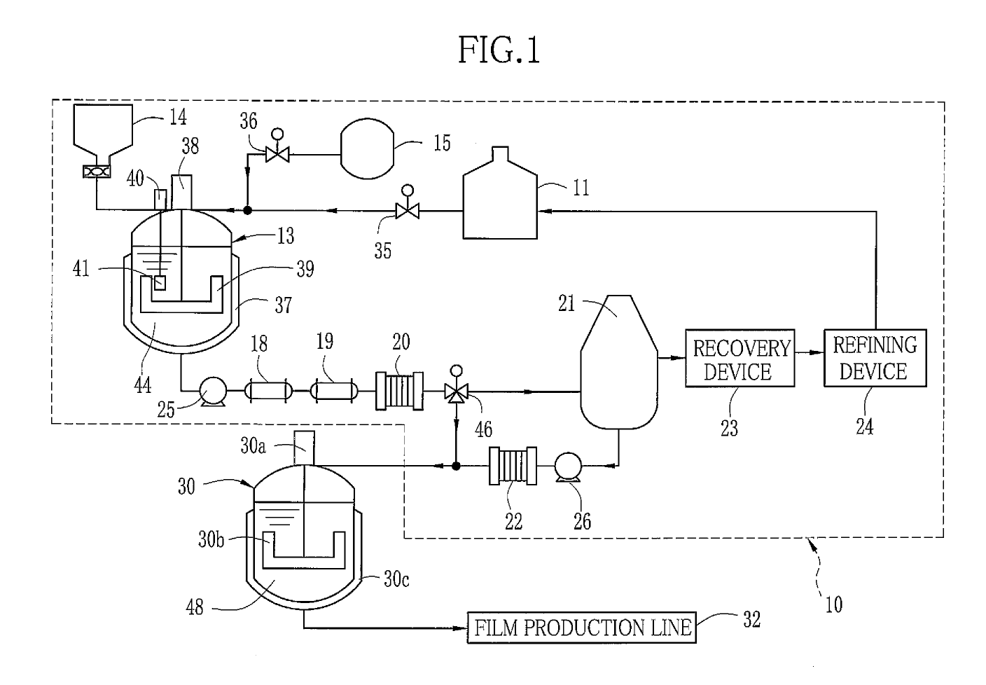

As shown in FIG. 1, a dope production line 10 includes a solvent tank 11 for storing a solvent, a dissolving tank 13 for mixing the solvent and TAC or the like, a hopper 14 for supplying the TAC to the dissolving tank 13, an additive tank 15 for storing an additive liquid, a heater 18 for heating a swelling liquid to be described later, a temperature regulator 19 for regulating the temperature of a prepared dope, a filtration device 20 for filtering the prepared dope, a flush device 21 for concentrating the prepared dope, a filtration device 22 for filtering the concentrated dope, a recovery device 23 for recovering the solvent, and a refining device 24 for refining the recovered solvent. A pump 25 is disposed in a downstream side from the dissolving tank 13. A pump 26 is disposed in a downstream side from the flush device 21. The pump 25 is used to supply a swelling liquid 44 contained in the dissolving tank 13 to the heater 18. The pump 26 is used to supply the concentrated dope contained in the flush device 21 to the filtration device 22. The dope production line 10 is connected to a film production line 32 via a stock tank 30 disposed in a downstream side from the filtration devices 20 and 22.

First of all, a valve 35 disposed in a pipe connecting the solvent tank 11 with the dissolving tank 13 is opened, and the solvent is sent from the solvent tank 11 to the dissolving tank 13. Next, the TAC stored in the hopper 141s supplied to the dissolving tank 13 while its mount is measured. A necessary amount of additive liquid is supplied to the dissolving tank 13 from the additive tank 15 by opening/closing a valve 36 disposed in a pipe connecting the additive tank 15 and the dissolving tank 13. Note that, in a case where the additive is liquid at room temperature, it is possible to send the additive in a liquid state to the dissolving tank 13, in addition to supplying as solution. Further, in a case where the additive is solid, the hopper 14 can be used to supply the additive to the dissolving tank 13. Further, in a case where plural kinds of additives are to be added, the additive tank 15 may contain a solution in which plural kinds of additives are dissolved. Additionally, plural additive tanks 15 can be used in accordance with the kinds of the solutions containing each additive for the purpose of supplying each additive to the dissolving tank 13 through independent pipes.

Although the solvent (including a mixed solvent), the TAC, and the additive are supplied to the dissolving tank 13 in this order in the above description, the order is not limited thereto. For example, after the TAC is supplied to the dissolving tank 13 while its amount is measured, an adequate amount of the solvent may be supplied thereto. Further, it is not always necessary to preliminarily supply the additive to the dissolving tank 13, and the additive may be mixed with a mixture of the TAC and the solvent in the following process.

The dissolving tank 13 is provided with a jacket 37 for covering an outer surface thereof, and a first stirrer 39 rotated by a motor 38. Additionally, the dissolving tank 13 is preferably provided with a second stirrer 41 rotated by a motor 40. Note that the first stirrer 39 is preferably provided with an anchor blade, and the second stirrer 41 is preferably a stirrer of dissolver type. The temperature in the dissolving tank 13 is preferably regulated by pouring a heat transfer medium into the jacket 37. A preferable temperature range in the dissolving tank 13 is not less than −10° C. and not more than 55° C. The first stirrer 39 and the second stirrer 41 are arbitrarily selected and rotated to prepare the swelling liquid 44 in which the TAC is swelled in the solvent.

The swelling liquid 44 prepared in the dissolving tank 13 is supplied to the heater 18 with use of a pump 25. Preferably, the heater 18 includes a pipe provided with a jacket, and applies pressure to the swelling liquid 44. While the swelling liquid 44 is heated or while the swelling liquid 44 is pressurized and heated, the TAC or the like is dissolved into the solvent to obtain the dope. Note that, the preferable temperature range of the swelling liquid 44 is not less than 0° C. and not more than 97° C. in this case. A heating-dissolving method and a cooling-dissolving method are arbitrarily selected to be performed, and thereby the TAC can be dissolved into the solvent sufficiently. The temperature of the prepared dope is regulated by the temperature regulator 19 such that the temperature of the dope becomes approximately the room temperature. Thereafter, the dope is filtered by the filtration device 20 to remove impurities therefrom. An average diameter of the pores of a filtration filter used for the filtration device 20 is preferably not more than 100(m. The filtering flow volume of the dope is preferably equal to or at least 50 L/h. Thereafter, the dope after filtration is supplied to the stock tank 30 via a valve 46.

The dope can be used as a primary dope to be described later. The method for dissolving the TAC after preparing the swelling liquid 44 takes longer time when the concentration of the TAC is higher. Therefore, there arises a problem in that the manufacturing cost increases. In this case, a concentration process is preferably performed. In the concentration process, after the dope having a concentration lower than a desired TAC concentration is prepared, the dope having a low concentration is concentrated to obtain the dope having the desired TAC concentration. The dope filtered by the filtration device 20 is supplied to the flush device 21 via the valve 46. The flush device 21 evaporates a part of the solvent in the dope. Solvent gas generated due to the evaporation of the solvent in the flush device 21 is condensed to be liquidized by a condenser (not shown), and recovered by the recovery device 23. The recovered solvent is refined by the refining device 24 to be a solvent for preparing the dope, and reused, thus causing advantageous result in view of the cost.

The dope thus concentrated is taken out of the flush device 21 with use of the pump 26. Further, it is preferable that a defoaming process is performed in order to remove the bubbles contained in the dope. As the deforming process, various well-known methods are applicable. For example, there is an ultrasonic irradiation method. Thereafter, the dope is sent to the filtration device 22 to remove foreign substances therefrom. Note that the temperature of the dope is preferably not less than 0° C. and not more than 200° C. at this time. Then, the dope is supplied to the stock tank 30.

According to the methods described above, it is possible to produce the dope having the TAC concentration within a predetermined range. Note that the produced dope (hereinafter referred to as primary dope) 48 is stored in the stock tank 30.

Note that although the polymer used for the primary dope 48 is TAC in the dope production line 10, the polymer is not limited to the TAC in the present invention. Other cellulose acylate may be used in the present invention.

The above-described dissolving method, the filtration method, the defoaming method, and the adding method of the materials and additives performed in the dope production line 10 are described in detail in paragraphs [0517] to [0616] in Japanese Patent Laid-Open Publication No. 2005-104148. The description is also applicable to the present invention.

(Film Production Process)

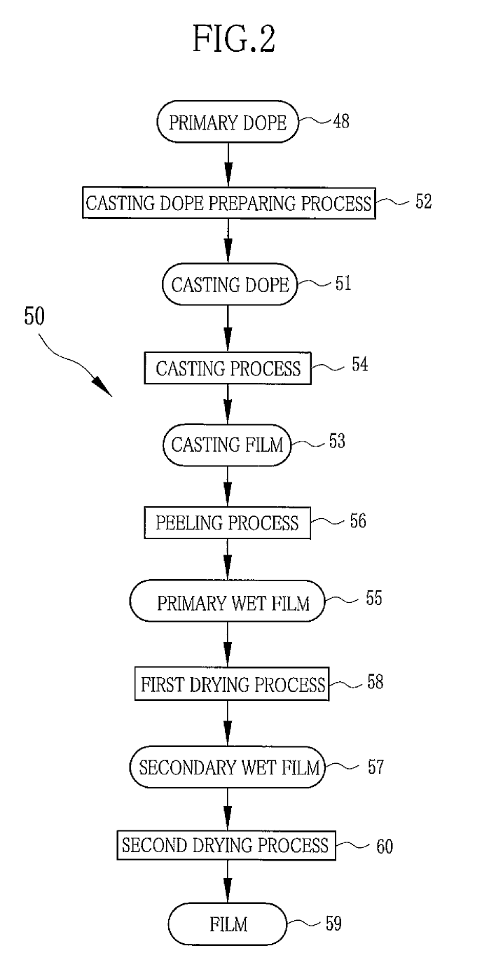

Next, a film production process 50 of the present invention is described. As shown in FIG. 2, the film production process 50 includes a casting dope preparing process 52, a casting process 54, a peeling process 56, a first drying process 58, and a second drying process 60. In the casting dope preparing process 52, a casting dope 51 is prepared from the primary dope 48 obtained as described above. In the casting process 54, the casting dope 51 is cast onto a moving support to form a casting film 53. In the peeling process 56, the casting film 53 after being solidified enough to be peelable and have a self-supporting property is peeled from the support to form a primary wet film 55. In the first drying process 58, the primary wet film 55, which contains a compound constituting the solvent (namely, solvate, hereinafter referred to as liquid compound, and the liquid compound is not a compound of high order generated between molecule of solute or ion and molecule of solvent or ion, but a compound constituting the solvent in the present invention) remained therein, is caused to contact with a first dry gas containing a compound having a molar volume smaller than that of the liquid compound (hereinafter referred to as small-volume compound) in order to eliminate the liquid compound to form a secondary wet film 57. In the second drying process 60, a second dry gas for eliminating the residual small-volume compound and the liquid compound from the secondary wet film 57 is caused to contact with the secondary wet film 57. Note that a winding process may be performed to wind the film 59 around a roll to form a film roll after the second drying process 60.

(Solution Casting Method)

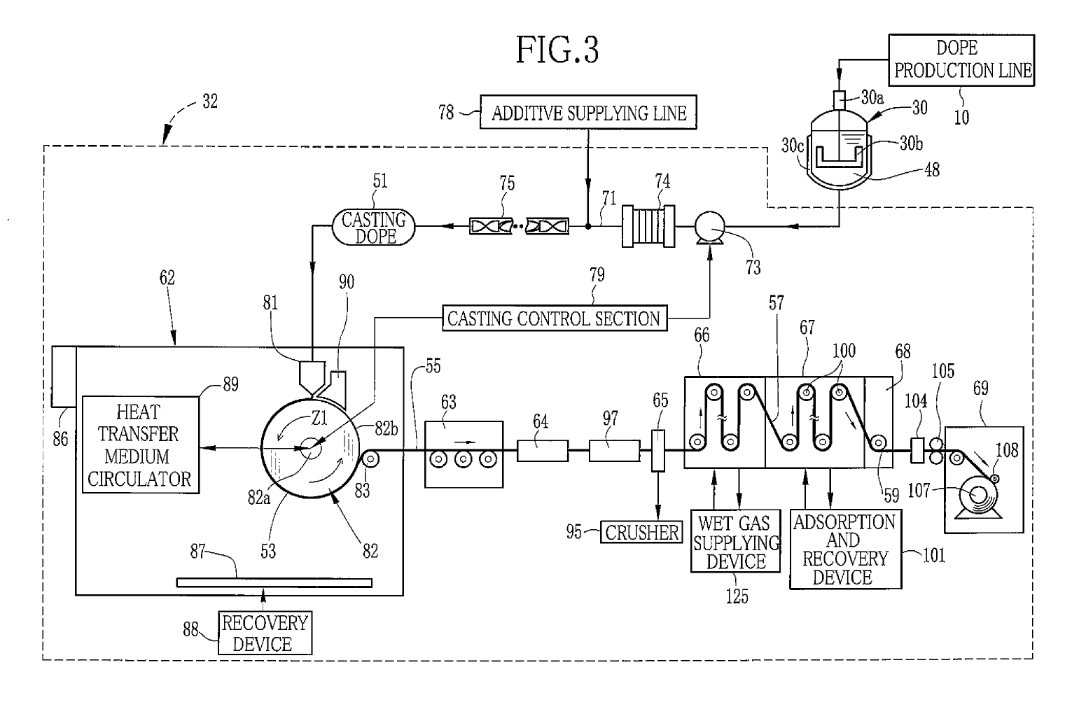

As shown in FIG. 3, a film production line 32 includes a casting chamber 62, a transfer section 63, a pin tenter 64, a slitting device 65, a first drying chamber 66, a second drying chamber 67, a cooling chamber 68, and a winding chamber 69.

The stock tank 30 is provided with a stirrer 30b rotated by a motor 30a, and a jacket 30c, and stores the primary dope 48 as a material of the film 59. The jacket 30c is provided on an outer face of the stock tank 30 so as to always keep the temperature of the primary dope 48 approximately constant. Since the stirrer 30b is rotated in the stock tank 30, it is possible to prevent aggregation of the polymer and the like such that the quality of the primary dope 48 is maintained.

The stock tank 30 is connected to the casting chamber 62 via a pipe 71. The pipe 71 is provided with a gear pump 73, a filtration device 74, and an in-line mixer 75. An additive supplying line 78 is connected in an upstream side from the in-line mixer 75 of the pipe 71. The additive supplying line 78 adds a predetermined amount of additives such as UV-absorbing agent, matting agent, and retardation controller, or polymer solution containing the additives (hereinafter referred to as additive mixture) to the primary dope 48 contained in the pipe 71. The in-line mixer 75 stirs and mixes the primary dope 48 and the additive mixture to prepare the casting dope 51.

The gear pump 73 is connected to a casting control section 79. The casting control section 79 uses the gear pump 73 to supply a predetermined flow volume of the casting dope 51 to a casting die 81 disposed in the casting chamber 62.

The casting chamber 62 includes the casting die 81 for discharging the casting dope 51, a casting drum 82 as a support on which the casting dope 51 is hardened (solidified) enough to be peelable and have a self-supporting property to be a casting film 53, a peeling roller 83 for peeling the casting film 53 from the casting drum 82, a temperature regulator 86 for keeping the temperature inside the casting chamber 62 within a predetermined range, a condenser 87 for condensing and liquidizing the solvent vapor in the casting chamber 62, and a recovery device 88 for recovering the condensed and liquidized solvent. The condensed and liquidized solvent is recovered by the recovery device 88 to be refined, and thereafter reused as the solvent for preparing the dope. As described above, the recovery device 88 keeps the vapor pressure of the solvent contained in atmosphere in the casting chamber 62 within a predetermined range.

(Casting Die)

The front end of the casting die 81 includes a discharge port for discharging the casting dope 51. The casting dope 51 is cast through the discharge port onto a peripheral surface 82b of the casting drum 82 disposed below the discharge port. The casting dope 51 cast from the casting die 81 forms a casting bead along the peripheral surface 82b of the casting drum 82. The casting dope 51 on the peripheral surface 82b becomes the casting film 53.

The material for the casting die 81 is preferably precipitation hardened stainless steel. A coefficient of thermal expansion thereof is preferably 2×10⁻⁵ (° C.⁻¹) or less. A material whose resistance to corrosion is substantially equivalent to that of SUS316 subjected to a compulsory corrosion examination using an electrolyte aqueous solution may be used for the casting die 81. Further, the material has resistance to corrosion such that pitting is not caused on a gas-liquid interface after being soaked in a mixed liquid of dichloromethane, methanol, and water for three months. It is preferable that the material for the casting die 81 is left for one month or more after being cast, and then machined. By virtue of this, the casting dope 51 can smoothly and uniformly flow inside the casting die 81. Accordingly, it is possible to prevent occurrence of streaks or the like on the casting film 53 to be described later. Accuracy of finishing of a contact surface between the casting die 81 and the liquid is preferably 1 μm or less in the surface roughness, and straightness thereof is preferably 1 μm/m or less in any direction. A width of slit clearance of the discharge port can be automatically adjusted within the range of 0.5 mm to 3.5 mm. With respect to a corner portion of a lip edge of the casting die 81, which contacts with the liquid, a chamfered radius R thereof is preferably adapted to be 50 μm or less in the entire width. Shearing speed for the casting dope 51 inside the casting die 81 is preferably adjusted in the range of 1 to 5000 (1/sec). The casting die 81 as described above is used to form the casting film 53 having no streaks and thickness unevenness on the peripheral surface 82b of the casting drum 82.

Although the width of the casting die 81 is not especially limited, it is preferable that the width thereof is 1.1 to 2.0 times the width of the film as a final product. The casting die 81 is preferably provided with a temperature controller (not shown) in order to maintain the temperature inside the casting die 81 at a predetermined value during the film production. The casting die 81 is preferably of coat-hanger type. Furthermore, it is more preferable that thickness adjusting bolts (heat bolts) are disposed in a width direction of the casting die 81 at predetermined intervals and the casting die 81 is provided with an automatic thickness adjusting mechanism utilizing the heat bolts. As for use of the heat bolts, it is preferable that a profile is set along a preset program in accordance with a liquid amount sent with use of the gear pump 73 for the purpose of producing the film. Additionally, the adjustment amount of the heat bolts may be feedback-controlled along an adjustment program on the basis of a profile of a thickness gauge (an infrared thickness gauge, for example, not shown) in the film production line 32. A thickness difference between any two points, which are located in an area except a casting edge portion, of the film as a product is preferably regulated to be at most 1 μm in the width direction of the film. A difference between the largest thickness and the minimum thickness of the film is preferably regulated to be at most 3 μm, and more preferably at most 2 μm in the width direction of the film. Further, the thickness accuracy is preferably regulated to at most ±1.5%.

More preferably, a hardened film is formed on the lip edge of the casting die 81. A method for forming the hardened film is not especially limited, and there are ceramic coating, hard chrome-plating, nitriding treatment, and the like, for example. When the ceramic is utilized as the hardened film, it is preferable that the ceramic can be ground, has low porosity, and is excellent in strength and resistance to corrosion, in addition to excellent adhesion with the casting die 81 and poor adhesion with the casting dope 51. Concretely, there are tungsten carbide (WC), Al₂O₃, TiN, Cr₂O₃, and the like. Among those, WC is especially preferable. It is possible to perform WC coating by a thermal spraying method.

(Casting Drum)

The casting drum 82 is disposed below the casting die 81. The casting drum 82 is an approximately circular cylinder or a cylinder hollow, and has an axis 82a connected to the casting control section 79. Under the control of the casting control section 79, the casting drum 82 is caused to rotate around the axis 82a, and the peripheral surface 82b of the casting drum 82 moves in a moving direction Z1 at a predetermined speed.

Further, a heat transfer medium circulator 89 is attached to the casting drum 82 in order to keep the temperature of the peripheral surface 82b of the casting drum 82 approximately constant within a desired range. The heat transfer medium kept at a desired temperature by the transfer medium circulator 89 passes through a path for the heat transfer medium in the casting drum 82, and thereby the temperature of the peripheral surface 82b can be kept within a desired range.

The width of the casting drum 82 is not especially limited, however, the width thereof is preferably 1.1 to 2.0 times the casting width of the dope. Further, it is preferable that the peripheral surface 82b of the casting drum 82 is ground such that the surface roughness thereof becomes at most 0.01 μm. Surface defect of the peripheral surface 82b should be reduced to the minimum extent. Concretely, it is preferable that there in no pin holes having a diameter of 30 μm or more, at most one pin hole having a diameter of less than 30 μm and not less than 10 μm per square meter, and at most two pin holes having a diameter of less than 10 μm per square meter. Preferably, the vertical position variation of the peripheral surface 82b in accordance with the rotation of the casting drum 82 is adjusted at most 200 μm, the speed fluctuation of the casting drum 82 is adjusted to be at most 3%, and meandering of the casting drum 82 in the width direction caused by one rotation is regulated at most 3 mm.

The casting drum 82 is preferably made of stainless, and more preferably made of SUS316 so as to have sufficient resistance to corrosion and strength. The peripheral surface 82b of the casting drum 82 is preferably subjected to the chrome-plating so as to have sufficient hardness and resistance to corrosion for the casting of the casting dope 51.

(Peeling Roller)

A peeling roller 83 is disposed at the vicinity of the peripheral surface 82b of casting drum 82 in a downstream side from the casting die 81 in the moving direction Z1. The casting film 53 is peeled from the casting drum 82 by the peeling roller 83 to form the primary wet film 55.

The decompression chamber 90 is disposed at the vicinity of the peripheral surface 82b of the casting drum 82 in an upstream side from the casting die 81 in the moving direction Z1. The decompression chamber 90 is connected to a controller (not shown). Under the control of not-shown controller, the decompression chamber 90 can decompress the casting bead in the upstream side from the casting die 81, such that the pressure in the upstream side is lower than that in the downstream side in a range of 10 Pa to 2000 Pa. A jacket (not shown) is preferably attached to the decompression chamber 90 so as to keep the temperature inside the decompression chamber 90 at a predetermined value. The temperature of the decompression chamber 90 is not especially limited, however, preferably not less than the condensing point of the solvent contained in the dope.

The transfer section 63, the pin tenter 64, and the slitting device 65 are disposed in this order in the downstream side from the casting chamber 62. In the transfer section 63 and the pin tenter 64, the primary wet film 55 is dried.

The transfer section 63 is provided with plural rollers for guiding the primary wet film 55 sent from the casting chamber 62.

The pin tenter 64 has plural pins for fixing the primary wet film 55. The plural pins are attached to a circular chain. In accordance with the movement of the chain, pins move endlessly. In the pin tenter 64, both side ends of the primary wet film 55 sent from the peeling roller 83 are pierced by the pins such that the primary wet film 55 is fixed. Two chains are moved in a predetermined direction in the pin tenter 64. A dry gas supplying device (not shown) is provided in the pin tenter 64. The dry gas supplying device causes dry gas adjusted at predetermined conditions to circulate in the pin tenter 64, or applies the dry gas to the primary wet film 55 so as to dry the primary wet film 55.

The slitting device 65 is provided between the pin tenter 64 and the first drying chamber 66. The slitting device 65 includes a crusher 95. Both side ends of the primary wet film 55 are cut off by the slitting device 65 and sent to the crusher 95. The side ends of the primary wet film 55 thus cut away are crushed into pieces by the crusher 95 to be reused as a material for preparing the primary dope 48.

Note that, between the pin tenter 64 and the slitting device 65, a clip tenter 97 may be provided. In the clip tenter 97, both side ends of the primary wet film 55 are held, and the primary wet film 55 is stretched in its width or longitudinal direction while being dried. The clip tenter 97 is a drying device having clips for holding the primary wet film 55. After being subjected to the stretching process under predetermined conditions in the clip tenter 97, the primary wet film 55 can achieve desired optical properties.

The first drying chamber 66 includes plural rollers for guiding the primary wet film 55 sent from the slitting device 65, and the like. In the first drying chamber 66, a predetermined gas is applied to the primary wet film 55 guided by the rollers to form the secondary wet film 57, and the secondary wet film 57 is sent to the second drying chamber 67. The details of the first drying chamber 66 are described later.

Additionally, the second drying chamber 67 includes plural rollers 100 and an adsorption and recovery device 101. Further, a compulsory neutralization device (neutralization bar) 104 is disposed in the downstream side from the cooling chamber 68 next to the second drying chamber 67. Further, in this embodiment, a knurling roller 150 is disposed in the downstream side from the compulsory neutralization device 104.

In the second drying chamber 67, the secondary wet film 57 is bridged over the rollers 100 to be transported. The liquid compound having evaporated from the secondary wet film 57 in the second drying chamber 67 is recovered together with gas contained in the second drying chamber 67 by the adsorption and recovery device 101. The adsorption and recovery device 101 adsorbs and recovers the liquid compound from the recovered gas. The gas from which the liquid compound is removed is sent again as dry gas into the second drying chamber 67. Note that the second drying chamber 67 is preferably divided into plural sections so as to vary the drying temperature for each section. Additionally, a preliminary drying chamber (not shown) may be disposed between the first drying chamber 66 and the second drying chamber 67 to preliminarily dry the secondary wet film 57. Thereby, it is possible to prevent the rapid change in the temperature of the secondary wet film 57 in the second drying chamber 67, and further deformation of the secondary wet film 57 or the film 59.

The secondary wet film 57 is transferred to the cooling chamber 68 to be cooled to approximately room temperature therein. Note that a humidity control chamber (not shown) may be disposed between the second drying chamber 67 and the cooling chamber 68. In the humidity control chamber, air adjusted to have desired humidity and temperature is blown to the secondary wet film 57. Thereby, it is possible to prevent curing of the secondary wet film 57 and defect in the winding process. After passing through the cooling chamber 68, the secondary wet film 57 is transferred as the film 59 to the compulsory neutralization device 104.

The compulsory neutralization device 104 regulates the voltage applied to the film 59 during transportation within a predetermined range (for example, in the range of −3 kV to 3 kV). The knurling roller 105 applies knurling on both side ends of the film 59 by performing emboss processing. Note that the difference between the highest point and the lowest point of unevenness caused by the knurling is preferably in the range of 1 μm to 200 μm.

A winding roller 107 and a press roller 108 are provided in the winding chamber 69. While a desired tension is applied to the film 59 by the press roller 108, the film 59 is wound by the winding roller 107 at a predetermined speed in the winding chamber 69.

(First Drying Chamber)

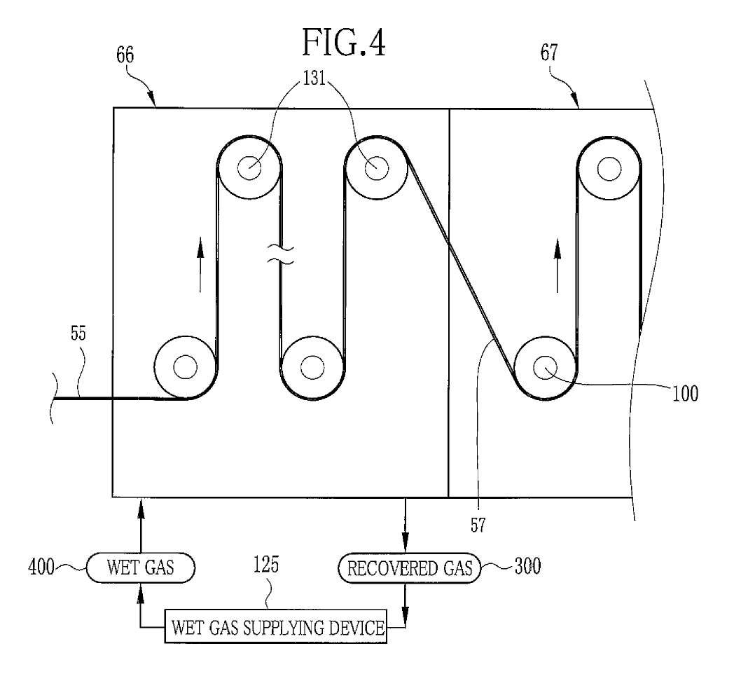

As shown in FIG. 4, the first drying chamber 66 includes plural rollers 131 disposed in a staggered arrangement. The rollers 131 guide the primary wet film 55 sent from the slitting device 65 to the second drying chamber 67. The first drying chamber 66 includes an air duct (not shown) a supply air duct (not shown). The first drying chamber 66 is connected to a wet gas supplying device 125 via the air duct and the supply air duct. The wet gas supplying device 125 recovers the gas inside the first drying chamber 66 as a recovered gas 300 via the air duct, and forms wet gas 400 adjusted at predetermined conditions. Then the wet gas supplying device 125 supplies the wet gas 400 to the first drying chamber 66 via the supply air duct.

(Wet Gas Supplying Device)

Next, the wet gas supplying device 125 is described in detail hereinbelow.

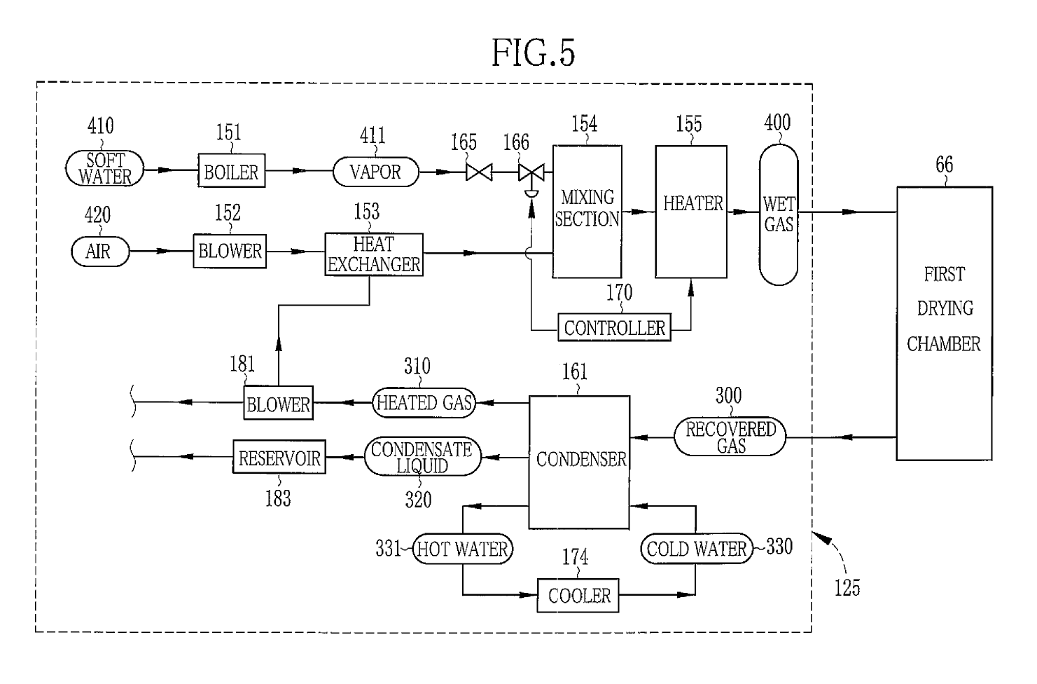

As shown in FIG. 5, the wet gas supplying device 125 includes a boiler 151, a blower 152, a heat exchanger 153, a mixing section 154, a heater 155, and a condenser 161. The boiler 151 heats soft water 410 to form water vapor 411. The blower 152 sends dry air 420 to the heat exchanger 153. The heat exchanger 153 heats the air 420 sent by the blower 152. The mixing section 154 mixes the air 420 having passed through the heat exchanger 153 and the water vapor 411 to form the wet gas 400. The heater 155 heats the wet gas 400 and send the heated wet gas 400 to the first drying chamber 66. The condenser 161 condenses the recovered gas 300 which is recovered from the first drying chamber 66 into heated gas 310 and a condensate liquid 320.

A pressure reducing valve 165 and a flow control valve 166 are provided in a pipe connecting the boiler 151 and the mixing section 154. The pressure reducing valve 165 decompresses the water vapor 411 to have a predetermined pressure. The flow control valve 166 controls flow volume of the water vapor 411. Further, through the controller 170, the flow control valve 166 and the heater 155 are connected to each other. The controller 170 controls the flow volume and temperature of the wet gas 400. The flow volume and temperature of the wet gas 400 may be controlled based on a value M1 read by a sensor (not shown) provided for the air duct, the supply air duct, or the like. Alternatively, the flow volume and temperature of the wet gas 400 may be controlled based on the value M1 depending on the producing conditions in the solution casting method. The value M1 denotes molecular mass of water contained in the wet gas 400 per unit volume.

A cooler 174 is connected to the condenser 161. The cooler 174 sends cold water 330 to the condenser 161. The cold water 330 sent to the condenser 161 is used to condense the recovered gas 300. Due to the condensation of the recovered gas 300, the cold water 330 becomes hot water 331. In the cooling chamber 174, the recovered hot water 331 is cooled. The cooled water is sent again as the cold water 330 to the condenser 161.

Part of the heated gas 310 generated by the condenser 161 is sent to the heat exchanger 153 by the blower 181, such that the heat of the heated gas 310 is reused. A redundant amount of the heating gas 310 is discarded.

The condensed water, solvent, or a condensate liquid 320 as a mixture of the condensed water and the solvent is sent to a reservoir 183. The reservoir 183 includes a concentration sensor for detecting the concentration of the solvent. The condensate liquid 320 is subjected to a predetermined process to be discarded.

Next, a representative method for producing the film 59 using the film production line 32 as described above is described hereinbelow. As shown in FIG. 3, the primary dope 48 in the stock tank 30 is stirred by the rotation of the stirrer 30b so as to be always kept uniform. Additives such as plasticizer may be added to the primary dope 48 while the primary dope 48 is stirred. The heat transfer medium is supplied to the inside of the jacket 30c such that the temperature of the primary dope 48 is kept approximately constant within the range of 25° C. to 35° C.

The casting control section 79 controls the gear pump 73 such that the gear pump 73 supplies the primary dope 48 to the pipe 71 via the filtration device 74. The primary dope 48 is filtered by the filtration device 74. The additive supplying line 78 supplies the additive mixture containing the matting agent, the UV-absorbing agent, and the like to the pipe 71. The primary dope 48 and the additive mixture are stirred and mixed in the in-line mixer 75 to form the casting dope 51. The temperature of the primary dope 48 is preferably kept approximately constant within the range of 30° C. to 40° C. in the in-line mixer 75. The mixing ratio of the primary dope 48, the matting agent, and the UV-absorbing agent is not especially limited, however preferably within the range of 90 wt %:5 wt %:5 wt % to 99 wt %:0.5 wt %:0.5 wt %. The casting dope 51 is supplied to the casting die 81 in the casting chamber 62 with use of the gear pump 73.

The vapor pressure of the solvent vapor contained in the atmosphere in the casting chamber 62 is kept approximately constant within a predetermined range by the recovery device 88. The temperature of the atmosphere in the casting chamber 62 is kept approximately constant within the range of −10° C. to 57° C. by the temperature regulator 86.

The casting control section 79 controls the casting drum 82 such that the casting drum 82 rotates around the axis 82a. The peripheral surface 82b of the casting drum 82 moves in the moving direction Z1 at a predetermined speed (within the range of 50 m/min to 200 m/min) in accordance with the rotation of the casting drum 82. The temperature of the peripheral surface 82b is kept approximately constant within the range of −10° C. to 10° C. by the heat transfer medium circulator 89.

The casting dope 51 is discharged from the discharge port of the casting die 81 onto the peripheral surface 82b. Thereby, the casting film 53 is formed on the peripheral surface 82b. The casting film 53 is cooled on the peripheral surface 82b and turns into gel state to be hardened or solidified.

The solidified casting film 53 is peeled as the primary wet film 55 from the peripheral surface 82b with the support of the peeling roller 83. The primary wet film 55 is guided to the transfer section 63 by the peeling roller 83. Dry gas adjusted at a predetermined condition is applied to the primary wet film 55 in the transfer section 63.

The primary wet film 55 is guided from the transfer section 63 to the pin tenter 64. Each side end of the primary wet film 55 is held by a fixing device including pins at an inlet of the pin tenter 64. The primary wet film 55 is transported while being held by the fixing device and subjected to a drying process under a predetermined condition in the pin tenter 64. The primary wet film 55 released from the fixation of the fixing device is transported to the clip tenter 97. Each side end of the primary wet film 55 is held by a holding device including clips at an inlet of the clip tenter 97. The primary wet film 55 is transported while being held by the holding device and subjected to a drying process under a predetermined condition in the clip tenter 97. While being transported in the clip tenter 97, the primary wet film 55 is subjected to a stretching process in a predetermined direction by the holding device.

The primary wet film 55 is dried in the clip tenter 97 or the like until the residual amount of the solvent in the primary wet film 55 reaches a predetermined amount, and thereafter sent to the slitting device 65. Both side ends of the primary wet film 55 are cut off by the slitting device 65. The side ends of the primary wet film 55 thus cut away are sent to the crusher 95 by a cut blower (not shown), and crushed into chips by the crusher 95. The chips of the film are reused to prepare the dope.

The primary wet film 55 whose side ends were cut away is sent to the first drying chamber 66. The primary wet film 55 is subjected to the first drying process 58 in the first drying chamber 66, and thereafter guided as the secondary wet film 57 to the second drying chamber 67. The first drying process 58 performed in the first drying chamber 66 is described in detail later.

The secondary wet film 57 is subjected to the second drying process 60 in the second drying chamber 67. The secondary wet film 57 is caused to contact with dry air and dried to be a film 59 in the second drying process 60. The second drying process 60 performed in the second drying chamber 67 is described in detail later. Although the temperature of dry air in the second drying chamber 67 is not especially limited, it is preferably within the range of 80° C. to 180° C., and more preferably within the range of 100° C. to 150° C.

The residual amount of the solvent in the film 59 is preferably at most 5 wt % on a dry basis after the second drying process 60. The residual amount of the solvent on a dry basis is a value calculated by a formula: [(x−y)/y]×100, in which x is weight of the film at the time of sampling and y is weight of the sampling film after being dried completely. The film 59 dried completely is transported to the cooling chamber 68. The film 59 is cooled to approximately room temperature in the cooling chamber 68.

The compulsory neutralization device 104 regulates the voltage applied to the film 59 during the transportation within a predetermined range (for example, within the range of −3 kV to 3 kV). Thereafter, the knurling is formed on the both side ends of the film 59 by performing emboss processing with use of the knurling roller 105. Finally, the film 59 is wound by the winding roller 107 disposed in the winding chamber 69. At the time of winding of the film 59, tension adjusted at a desired level is applied to the film 59 by the press roller 108. Note that the tension applied thereto is preferably gradually varied between the start of winding and the end of winding.

The film 59 to be wound by the winding roller 107 preferably has a length of 100 m or more in the longitudinal direction thereof (casting direction). The film 59 to be wound preferably has a width of 600 mm or more, and more preferably a width in the range of 1400 mm to 2500 mm. The film 59 having a width of 2500 mm or more is also effective in the present invention.

Further, the thickness of the film 59 is preferably in the range of 20 μm to 200 μm, and more preferably in the range of 40 μm to 100 μm.

Next, the first drying process 58 is described in detail hereinbelow.

As shown in FIG. 4, the first drying chamber 66 is filled with the wet gas 400 adjusted at a predetermined condition by the wet gas supplying device 125. The primary wet film 55 sent from the slitting device 65 is transported while being bridged over plural rollers 131 to be guided to the second drying chamber 67. As described above, the first drying process 58 with use of the wet gas 400 adjusted at a desired condition is performed in the first drying chamber 66. After being subjected to the first drying process 58 sufficiently, the primary wet film 55 becomes the secondary wet film 57.

Water molecules contained in the wet gas 400 are absorbed into the primary wet film 55 in the first drying process 58 with use of the wet gas 400. Since the water molecules are absorbed as described above, the liquid compounds are easily diffused in the primary wet film 55 and the secondary wet film 57. Accordingly, the liquid compounds easily reach the vicinity of the surfaces of the primary wet film 55 and the secondary wet film 57. As a result, the residual liquid compounds contained in the primary wet film 55 and the secondary wet film 57 are easily eliminated outside in the first drying process 58 and the second drying process 60. In the second drying process 60, due to the contact with dry air, the water molecules are eliminated together with the residual liquid compounds from the secondary wet film 57. The water molecule has molar volume smaller than that of the liquid compound, and is easily diffused in the secondary wet film 57, and therefore if the water molecule goes deep into the secondary wet film 57, it is possible to easily eliminate the water molecule outside. The first drying process 58 and the second drying process 60 make it possible to lower the drying temperature and shorten the time required for the drying process as a whole, in comparison with the conventional drying process using only the dry air.

Due to the absorption of the water molecules, the liquid compounds are easily diffused in the primary wet film 55 and the secondary wet film 57. The reason thereof is as follows.

The primary wet film 55 and the secondary wet film 57 are dried because the liquid compounds and small-volume compounds contained at the vicinity of the surfaces of the primary wet film 55 and the secondary wet film 57 are eliminated therefrom. Accordingly, a process in which liquid compounds and the like contained at the vicinity of the surfaces of the primary wet film 55 and the secondary wet film 57 are eliminated outside directly (hereinafter referred to as constant-rate drying state) predominates at an initial stage of the drying process. However, a process in which liquid compounds and the like contained in the primary wet film 55 and the secondary wet film 57 are diffused and reach the vicinity of the surface thereof and then are eliminated outside (hereinafter referred to as falling-rate drying state) predominates at or after a middle stage of the drying process.

After being subjected to the series of drying processes to turn into a gel state, the primary wet film 55 and the secondary wet film 57 have a network structure of polymer molecules. The liquid compounds and other compounds are contained in meshes of the network structure. Volume of the liquid compounds remained in the primary wet film 55 and the secondary wet film 57, that is, molar volume thereof is larger than that of the mesh of the network structure, and therefore the liquid compounds are not easily diffused in the primary wet film 55 and the secondary wet film 57. Accordingly, it is difficult to eliminate the liquid compounds deep inside the primary wet film 55 and the secondary wet film 57. In order to accelerate diffusion of the liquid compounds, there is known a method for raising the temperature during the drying process. However, when the primary wet film 55 and the secondary wet film 57 are dried at high temperature, polymer and the like are thermally decomposed, thus causing unfavorable result.

As in the case of the first drying process 58 of the present invention, when the wet gas 400 is applied to the primary wet film 55 and the water molecules each having a molar volume smaller than that of the liquid compound is absorbed into the primary wet film 55, the water molecules function to expand the meshes of the network structure. As the meshes of the network structure are expanded, the liquid compounds are easily diffused also at a low temperature. As a result, it becomes easy to eliminate the liquid compounds deep inside the primary wet film 55 and the secondary wet film 57.

As described above, according to the present invention, instead of the conventional drying process, the first drying process 58 as described above is performed, and therefore it is possible to shorten the time required for the drying process without performing the drying process at high temperature as in the case of conventional methods. In particular, the effect of the present invention is exerted prominently when the primary wet film 55 in the falling-rate drying state is subjected to the first drying process 58.

In the film production process 50 (see FIG. 2), methods for judging whether the primary wet film 55 is in the falling-rate drying state or not are as follows: (1) a method for judging based on whether the residual amount of the solvent contained in the casting film 53 and the primary wet film 55 are within a predetermined range or not; (2) a method for judging the primary wet film 55 at the time of being peeled from the support as being in the falling-rate drying state; and the like.

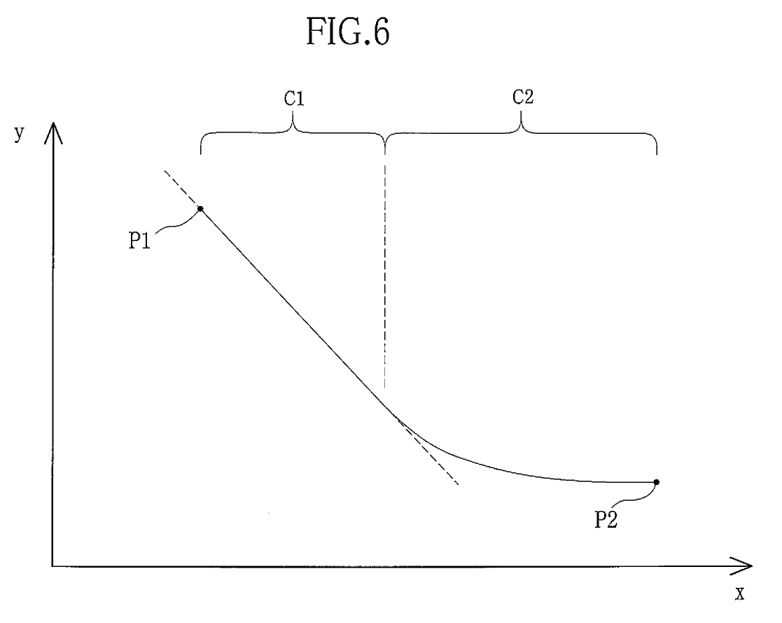

According to the method (1), in a drying experiment under a definite condition, the drying speed of the casting film 53 and the primary wet film 55, that is, a state in which a gradient is approximately constant in a plot of FIG. 6 may be referred to as a constant-rate drying state C1. The state after the constant-rate drying state C1 may be referred to as a falling-rate drying state C2. The plot of FIG. 6 shows the time required for the drying process in which the casting film 53 becomes the film 59 (elapsed time), and change in residual amount of the solvent. In FIG. 6, x-axis denotes the length of elapsed time, and y-axis denotes the residual amount of the solvent. A point P1 in FIG. 6 denotes the casting film 53 just after being formed on the support, and a point P2 in FIG. 6 denotes the film 59. Note that instead of using the plot, for example, a state in which the residual amount of solvent is 10 wt % or less may be referred to as the falling-rate drying state C2.

The thickness of the primary wet film 55 at the time of starting the first drying process 58 is preferably at least 30 μm, and more preferably at least 50 μm. Additionally, the upper limit of the thickness of the first wet film 55 at the time of starting the first drying process 58 is not especially limited, however the preferable thickness is not more than 100 μm.

The wet gas 400 used in the first drying process 58 preferably contains more water molecules, and has high temperature and high relative humidity. In particular, for the purpose of causing the primary wet film 55 to absorb the water molecules efficiently, it is more preferable that the temperature of the wet gas 400 is high and the relative humidity thereof is also high.

When the amount of saturated water vapor in the wet gas 400 is denoted by MS, a mass M1 of the water molecules contained in the wet gas 400 is preferably not less than 0.3 MS and not more than MS, and more preferably not less than 0.31 MS and not more than 0.5 MS. In a case where the weight M1 of the water molecules contained in the wet gas 400 is less than 0.3 MS, since the amount of the water molecules contained in the primary wet film 55 is low, the meshes of the network structure of the polymer molecules are not expanded sufficiently. As a result, the efficiency of drying the primary wet film 55 is not increased, and thus leading to unfavorable result.

When a boiling point of the small-volume compound is denoted by BP (° C.), the temperature of the wet gas 400 is preferably not less than BP (° C.) and not more than 3 BP (° C.), more preferably not less than BP (° C.) and not more than 2 BP (° C.), and most preferably not less than 1.1 BP (° C.) and not more than 1.7 BP (° C.). When the temperature of the wet gas 400 exceeds a melting point of the polymer molecule, the polymer molecule is thermally decomposed, thus causing decrease in the optical properties and mechanical properties of the film, thus causing unfavorable result.

Although water is used as the small-volume compound in the above embodiment, the present invention is not limited thereto. The small-volume compound means a compound having molar volume smaller than that of the liquid compound contained in the casting dope 51. As the molar volume of the small-volume compound becomes smaller in comparison with the mesh of the network structure, the mesh of the network structure is expanded more and more, and as a result the effect of accelerating diffusion of the liquid compounds is prominently exerted. The molar volume of the small-volume compound depends on the composition of the polymer, and preferably in the range of 5 (cm³/mol) to 150 (cm³/mol), and more preferably in the range of 10 (cm³/mol) to 100 (cm³/mol) at the temperature of 0° C. and at the atmosphere pressure of 1 atm. For the purpose of reducing the residual amount of the small-volume compound in the primary wet film 55, the molar volume of the liquid compound is preferably smaller.

Further, when the small-volume compound has compatibility with the solvent, since the solvent is dissolved into the small-volume compound, the liquid compound is easily diffused in the primary wet film 55, thus causing a favorable result.

When a compound having no compatibility with the polymer (such as water) is used as the small-volume compound, it is necessary to perform the first drying process 58 under the condition in which no dew condensation occurs on the primary wet film 55, namely under the condition in which the temperature of the primary wet film 55 is higher than the dew point of the wet gas 400. This is because the water molecules contained in the casting film 53 and the primary wet film 55 adversely affect the form of the film (for example, smoothness of the surface thereof) as a final product.

Further, in a case where the solvent contained in the casting dope 51 consists of a single compound, the single compound is the liquid compound. In a case where the solvent contained in the casting dope 51 is mixture of plural compounds, the compound whose molar volume is smallest among the compounds to be eliminated may be the liquid compound.

Although water is used as the small-volume compound in the above embodiment, the present invention is not limited thereto. An organic compound, mixture of organic compound and water, or mixture of plural organic compounds may be used as the small-volume compound.

Hard water, soft water, pure water, and the like can be used as water. In view of protecting the boiler 151, soft water is preferably used. Foreign substances mixed into the primary wet film 55 cause decrease in optical properties and mechanical properties of the film 59 as a final product, and therefore water to be used preferably contains as few foreign substances as possible. Accordingly, for the purpose of preventing foreign substances from mixing with the primary wet film 55, soft water or pure water is preferably used as the small-volume compound, and pure water is more preferably used.

The pure water used in the present invention has electrical resistivity of at least 1 MΩ. The concentration of metal ion such as natrium ion, kalium ion, magnesium ion, and calcium ion contained in the pure water is less than 1 ppm, and the concentration of anion such as chlorine ion and nitric acid ion contained in the pure water is less than 0.1 ppm. The pure water can be easily obtained by reverse osmosis membrane, ion exchange resin, distillation, or combination of them.

Organic compound used as the small-volume compound are methanol, acetone, methylethyl ketone, and the like.

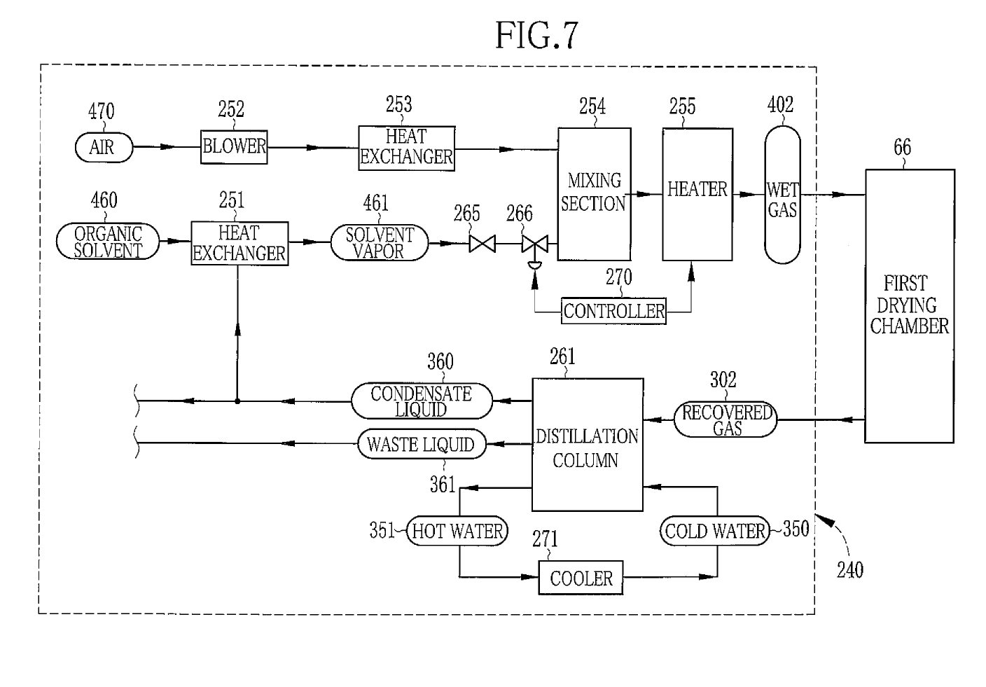

In a case where the organic compound is used as the small-volume compound, instead of using the wet gas supplying device 125, a wet gas supplying device 240 shown in FIG. 7 can be used. The wet gas supplying device 240 includes a heat exchangers 251 and 253, a blower 252, a mixing section 254, a heater 255, and a distillation column 261. The heat exchanger 251 heats an organic solvent 460 as the organic compound to form solvent vapor 461. The blower 252 sends dry air 470. The heat exchanger 253 heats the air 470 blown by the blower 252. The mixing section 254 mixes the air 470 having passed through the heat exchanger 253 and solvent vapor 461 to form wet gas 402. The heater 255 heats the wet gas 402 and sends the heated wet gas 402 to the first drying chamber 66. The distillation column 261 condenses recovered gas 302 which is recovered from the first drying chamber 66 to form a condensate liquid 360 and a waste liquid 361. Note that the wet gas 402 is air containing the organic compound and no moisture.

A pipe connecting the heat exchanger 251 and the mixing section 254 is provided with a pressure reducing valve 265 for decompressing the solvent vapor 461 to have a predetermined pressure and a flow control valve 266 for controlling the flow volume of the solvent vapor 461. Further, a controller 270 connects the flow control valve 266 and the heater 255. The controller 270 controls the flow volume and temperature of the wet gas 402 based on the value M1.

A cooler 271 is connected to the distillation column 261. The cooler 271 supplies cold water 350 to the distillation column 261. The cold water 350 sent to the distillation column 261 is used for condensation of the recovered gas 302. Due to the condensation of the recovered gas 302, the cold water 350 turns into hot water 351. The hot water 351 is recovered and cooled by the cooler 271 to be supplied again as the cold water 350 to the distillation column 261. Part of the condensate liquid 360 formed by the distillation column 261 is supplied to the heat exchanger 251 and the heat of the condensate liquid 360 is reused. The surplus condensate liquid 360 and other waste liquid 361 are subjected to a certain process to be discarded.

The wet gas supplying device 240 recovers the gas inside the first drying chamber 66 as the recovered gas 302, and supplies the new wet gas 402 adjusted at a predetermined condition to the first drying chamber 66. The first drying process 58 (see FIG. 2) is performed with use of the wet gas 402 by the wet gas supplying device 240 in the first drying chamber 66.

Although the air 420 and 470 are used in the above embodiment, the present invention is not limited thereto. Instead of the air 420 and 470, inert gas such as nitrogen, He, and Ar may be used in the present invention. Note that the amount of impurities contained in the air 420 is preferably as few as possible, as in the case of the small-volume compound.

Although zone drying is performed with use of the wet gas 400 in the first drying chamber 66 in the above embodiment, the present invention is not limited thereto. A drying method in which the wet gas 400 is applied to the film, a well-known drying method, or combination of them may be used for the purpose of performing the first drying process 58 in the first drying chamber 66.

Although the first drying process 58 is performed in the first drying chamber 66 in the above embodiment, the present invention is not limited thereto. The process in the first drying process 58 may be also performed in the transfer section 63, the pin tenter 64, and the clip tenter 97.

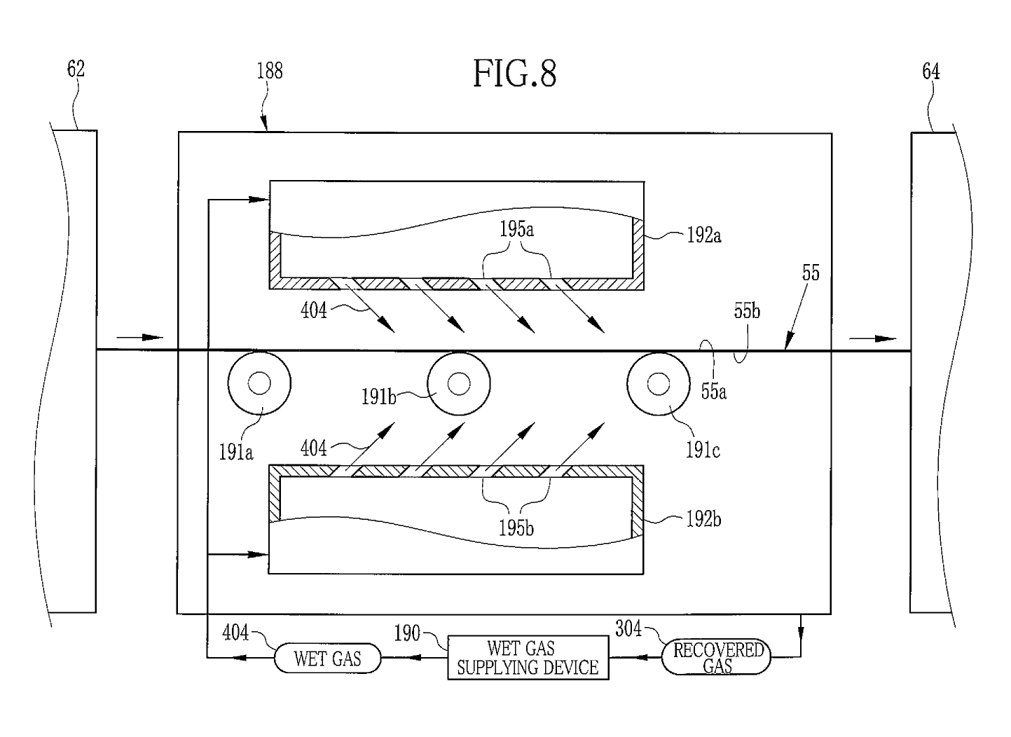

Next, a transfer section 188 for performing the first drying process 58 is described. As shown in FIG. 8, the transfer section 188 includes rollers 191a to 191c, and supply air ducts 192a and 192b. The primary wet film 55 sent from the casting chamber 62 is guided to the pin tenter 64 with the support of the rollers 191a to 191c. Air duct (not shown) provided at each of the supply air ducts 192a and 192b and the transfer section 188 is connected to the wet gas supplying device 190. The wet gas supplying device 190 has the same structure as that of the wet gas supplying device 125 described above. The wet gas supplying device 190 recovers air inside the transfer section 188 as the recovered gas 304 through the air duct, and produces the wet gas 404 adjusted at a predetermined condition from the recovered gas 304, and then supplies the wet gas 404 to the supply air ducts 192a and 192b. The supply air duct 192a has a slit 195a for supplying the wet gas 404 outside. Similarly, the supply air duct 192b has a slit 195b for supplying the wet gas 404 outside. The supply air duct 192a is disposed such that the slit 195a thereof faces a surface 55a of the primary wet film 55 having been in contact with the peripheral surface 82b of the casting drum 82 (hereinafter referred to as peeled surface 55a). The supply air duct 192b is disposed such that the slit 195b thereof faces a surface 55b of the primary wet film 55 as a rear surface of the peeled surface 55a (hereinafter referred to as air surface 55b).

The wet gas supplying device 190 can apply the wet gas 404 adjusted at a predetermined condition to the primary wet film 55 through the supply air ducts 192a and 192b to dry the primary wet film 55.

Although the supply air ducts 192a and 192b are used to apply the wet gas 404 to the primary wet film 55 in the transfer section 188 in the above embodiment, the present invention is not limited thereto. An air suction duct for recovering the wet gas 404 applied to the primary wet film 55 may be used together with the supply air ducts 192a and 192b.

Although the solution casting method in which the casting film 53 is cooled on the casting drum 82 to be solidified is described in the above embodiment, the present invention is not limited thereto. In a solution casting method in which the casting film 53 is dried to be solidified, the same effect can be achieved. Further, the present invention is also applicable to a solution casting method in which a moving casting band bridged over rotational rollers is used instead of the casting drum 82.

Although the wet gas 400 containing the soft water 410 is used to perform the first drying process 58 in the above embodiment, it is also possible to cause a liquid containing the small-volume compound such as the soft water 410, to contact with the casting film 53 and the primary wet film 55, instead of using the wet gas 400. In view of facilitating the production process and the production apparatus, the above embodiment is preferable. However, in another embodiment in which the liquid described above is caused to contact with the casting film 53 or the primary wet film 55, the same effect can be achieved. As a method for causing the liquid to contact with the casting film 53 or the primary wet film 55, in addition to a method for applying the liquid to the casting film 53 or the primary wet film 55, a method for soaking the casting film 53 or the primary wet film 55 into the liquid, and other methods can be used.

Next, another embodiment in which the liquid containing the small-volume compound is caused to contact with the casting film 53 or the primary wet film 55 is described. Note that the component parts which are identical or correspond to those of the above embodiment are denoted by the same reference numerals, and only the matters different from those in the above embodiment are described in detail.

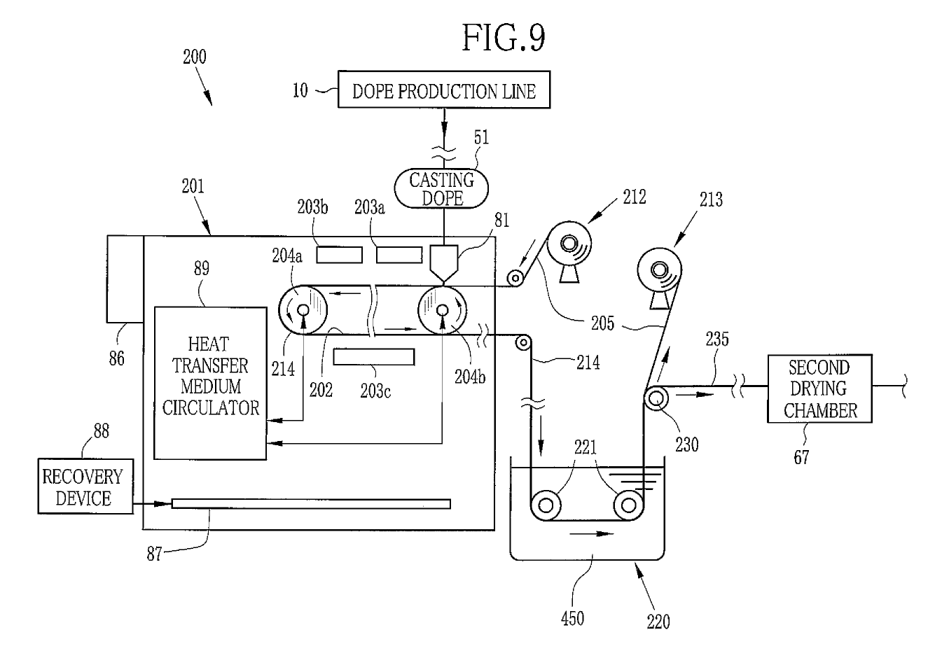

As shown in FIG. 9, a film production line 200 includes a casting chamber 201, a casting die 81, a support band 202, supply air ducts 203a to 203c, and drums 204a and 204b. Additionally, as in the case of the above embodiment, the temperature regulator 86, the condenser 87, the recovery device 88, and the heat transfer medium circulator 89 are provided in the casting chamber 201. The support band 202 is bridged over the drums 204a and 204b. By the rotation of the drums 204a and 204b, the support band 202 is moved in a predetermined direction.

The support film 205 is loaded in a roll manner in a feeding device 212. The support film 205 is sent from the feeding device 212 to the support band 202. The support film 205 sent from the support band 202 is transported in accordance with the moving of the support band 202, and then wound by a winding device 213.

At the vicinity of the drum 204b, the casting die 81 is set so as to be close to the support film 205. The casting dope 51 is cast onto a surface of the moving support film 205 through the casting die 81. The casting dope 51 becomes a casting film 214 on the surface of the support film 205.

The supply air ducts 203a to 203c are disposed at the vicinity of the support film 205. Dry gas is applied to the casting film 214 from the supply air ducts 203a to 203c.

A bath 220 for storing a liquid 450 is disposed between the drum 204b and the winding device 213. The temperature of the liquid 450 stored in the bath 220 is kept approximately constant within a predetermined range by a temperature controller (not shown). The liquid 450 contains the small-volume compound.

The bath 220 is provided with guide rollers 221. One of the guide rollers 221 guides the support film 205 and the casting film 214 moving together with the support band 202 into the liquid 450, and then the other of the guide rollers 221 takes out the support film 205 and the casting film 214 from the liquid 450.

A peeling roller 230 is disposed between the bath 220 and the winding device 213. The casting film 214 soaked into the liquid 450 is peeled from the support film 205 by the peeling roller 230, and sent as the wet film 235 to the transfer section 63.

In the film production line 200, it is possible to cause the casting film 214 to contact with the liquid 450 and absorb the small-volume compound. The wet film 235 passes through the transfer section 63 and the first dying chamber 67. Thereafter, in the second drying chamber 67 (see FIG. 3), the wet film 235 containing the small-volume compound is subjected to the same process as that in the second drying process 60 (see FIG. 2), and thereby the liquid compound contained in the wet film 235 can be easily eliminated.

Note that the wet gas 400 may be used to dry the casting film 214 instead of using the dry gas in the casting chamber 201.

According to the present invention, at the time of casting the dope, co-casting by simultaneous stacking or co-casting by sequential stacking may be performed. In the co-casting by simultaneous stacking, two or more kinds of dopes are subjected to co-casting simultaneously to be stacked. In the co-casting by sequential stacking, plural kinds of dopes are subjected to co-casting sequentially to be stacked. Note that both of them may be combined to be used. In the co-casting by simultaneous stacking, a casting die provided with a feed block may be used, or a multi-pocket-type casting die may be used. Note that, in a multilayer film obtained by the co-casting, any one of thickness of the layer at the side exposed to air and the thickness of the layer at the side of the support is preferably 0.5% to 30% relative to the total thickness of the film. Further, in the co-casting by simultaneous stacking, when the dope is cast onto the support from a die slit (discharge port), the dope with high viscosity is preferably surrounded by the dope with low viscosity. In the casting bead formed so as to extend from the die slit to the support, the dope exposed outside preferably has a relative proportion of alcohol higher than that of the dope located inside.

A structure of each of the decompression chamber, the support, and the like, co-casting, the peeling method, stretching, the drying condition in each process, the handling method, curling, the winding method after correcting smoothness, the solvent recovering method, and the film recovering method are described in detail in paragraphs [0617] to [0889] in Japanese Patent Laid-Open Publication No. 2005-104148. The description is also applicable to the present invention.

[Properties and Measuring Method]

The properties of the cellulose acylate film wound up and the measuring method thereof are described in paragraphs [0112] to [0139] in Japanese Patent Laid-Open Publication No. 2005-104148. The descriptions are also applicable to the present invention.

[Surface Treatment]

At least one of the surfaces of the cellulose acylate film is preferably subjected to a surface treatment. The surface treatment is preferably at least one of vacuum glow discharge, plasma discharge under the atmospheric pressure, UV-light irradiation, corona discharge, flame treatment, acid treatment, and alkali treatment.

[Functional Layer]

(Antistatic, Hardened Layer, Antireflection, Easily Adhesion, and Antiglare Function)

At least one of the surfaces of the cellulose acylate film may be subjected to an undercoating process. Further, it is preferable that the cellulose acylate film as the base film, to which other functional layers are added, is used as a functional material. As the functional layer, it is preferable that there is provided one of an antistatic layer, a hardened polymer layer, antireflection layer, an easily adhesive layer, an antiglare layer, and an optical compensation layer.

The functional layer preferably contains at least one kind of surfactants, lubricants, and matting agents in the range of 0.1 mg/m² to 1000 mg/m² each. More preferably, the functional layer contains at least one kind of antistatic agents in the range of 1 mg/m² to 1000 mg/m². Note that, other than the above, the method for forming the surface treatment functional layer for providing the cellulose acylate film with various functions and properties, and the conditions thereof are described in detail in paragraphs [0890] to [1087] in Japanese Patent Laid-Open Publication No. 2005-104148. The descriptions are also applicable to the present invention.

(Application)

The cellulose acylate film described above is effectively used particularly as a protective film for a polarizing filter. A liquid crystal display is obtained by adhering generally two polarizing filters, in which the cellulose acylate film is attached to a polarizer, to a liquid crystal layer. However, each location of the liquid crystal layer and the polarizing filter is not especially limited, and may be located in an arbitrary position based on a various known locations. Details about the liquid crystal displays of TN type, STN type, VA type, OCB type, reflective type, and other types are described in Japanese Patent Laid-Open Publication No. 2005-104148. The description is also applicable to the present invention. Additionally, in the same publication, there are described a cellulose acylate film provided with an optically anisotropic layer, and a cellulose acylate film provided with antireflective and antiglare functions. Further, in the same publication, there is described application of a biaxial cellulose acylate film provided with adequate optical properties as an optical compensation film. The biaxial cellulose acylate film also may be combined together with the protective film for a polarizing filter. The descriptions are also applicable to the present invention. The details thereof are described in paragraphs [1088] to [1265] in Japanese Patent Laid-Open Publication No. 2005-104148.

Further, the present invention is also applicable to a polymer film formed by the solution casting method in addition to the optical film described above. For example, there is a solid electrolyte film as a proton conductive material for use in a fuel cell. Note that the polymer used in the present invention is not limited to the cellulose acylate, and may be a well-known polymer.

Next, examples of the present invention are described. Hereinafter, Example 1 is described in detail. As to Examples 2 to 10 and Comparative Examples 1 to 5, the descriptions of conditions identical to those of Example 1 are omitted, and conditions different from those of Example 1 are described.

### Example 1

Next, Example 1 of the present invention is described. A composition in preparing the polymer solution (dope) for use in the film production is described hereinbelow.

[Preparation of Dope]

The composition of the compounds used for preparing the primary dope 48 is as follows.

### Relative Proportions of the Solid Constituents (Solute):

| | | |
|---|---|---|
| Triacetyl cellulose (substitution degree of 2.8) | 89.3 | wt % |
| Plasticizer A (triphenyl phosphate) | 7.1 | wt % |
| Plasticizer B (biphenyl diphenyl phosphate) | 3.6 | wt % |

### Relative Proportions of Mixed Solvent:

| | | |
|---|---|---|
| Dichloromethane | 80 | wt % |
| Methanol | 13.5 | wt % |
| N-butanol | 6.5 | wt % |

The solid constituents were arbitrarily added to the mixed solvent. The solid constituents and the mixed solvent are mixed together and stirred. Thereby, the solid constituents are dissolved into the mixed solvent to prepare the primary dope 48. Note that TAC concentration in the primary dope 48 was adjusted to be approximately 23 wt %. The primary dope 48 was filtered through filter paper (produced by Toyo Roshi Kaisha, Ltd., No. 63LB), and further filtered through a sintered metal filter (produced by Nippon Seisen Co., Ltd., 06N, with pores whose nominal diameter each was 10 μm). Thereafter, the primary dope 48 was filtered through a mesh filter, and poured into the stock tank 30.

### [Triacetyl Cellulose]

Note that, in triacetyl cellulose in this example, the residual amount of acetic acid was equal to or less than 0.1 wt %, the rate of content of Ca was 58 ppm, the rate of content of Mg was 42 ppm, the rate of content of Fe was 0.5 ppm, the rate of content of free acetic acid was 40 ppm, and the rate of content of sulfate ion was 15 ppm. The degree of substitution of the hydrogen atom in the hydroxyl group at sixth position to the acetyl group was 0.91. The percentage of the acetyl group which was substituted by the hydrogen atom in the hydroxyl group at sixth position was 32.5% relative to the whole acetyl group. When extraction of triacetyl cellulose was applied with acetone, the extract content was 8 wt %. A proportion of weight-average molecular weight to number average molecular weight was 2.5. Note that a yellow index of the obtained TAC was 1.7, the haze thereof was 0.08, and the transparency thereof was 93.5%. The TAC used in this example was synthesized from cellulose that was extracted from cotton.

### [Preparation of Liquid of Matting Agent]

The composition for preparing the liquid of matting agent was as follows.

| | | |
|---|---|---|
| Silica (AEROSIL R972, produced by NIPPON | 0.67 | wt % |
| AEROSIL CO., LTD.) | | |
| Triacetyl cellulose | 2.93 | wt % |
| Triphenyl phosphate | 0.23 | wt % |
| Biphenyl diphenyl phosphate | 0.12 | wt % |
| Dichloromethane | 88.37 | wt % |
| Methanol | 7.68 | wt % |

The liquid of matting agent was prepared from the above composition, and dispersed with use of an attritor such that volume average particle diameter thereof became 0.7 μm. Thereafter, the liquid of matting agent was filtered with use of Astropore filter (produced by Fuji Photo Film Co., LTD.), and then poured into a tank for the liquid of matting agent.

### [Preparation of Liquid of UV-Absorbing Agent]

The composition for preparing the liquid of UV-absorbing agent was as follows.

| | | |
|---|---|---|
| (2(2′-hydroxy-3′,5′-di-tert- | 5.83 | wt % |
| butylphenyl)-5-chlorobenzotriazol) | | |
| (2(2′-hydroxy-3′,5′-di-tert- | 11.66 | wt % |
| amylphenyl)benzotriazol) | | |
| Triacetyl cellulose | 1.48 | wt % |
| Triphenyl phosphate | 0.12 | wt % |
| Biphenyl diphenyl phosphate | 0.06 | wt % |
| Dichloromethane | 74.38 | wt % |
| Methanol | 6.47 | wt % |

The liquid of UV-absorbing agent was prepared from the above composition, and filtered with use of Astropore filter (produced by Fuji Film Co., LTD.), and then poured into a tank for supplying the liquid of UV-absorbing agent.

The film 59 was formed with use of the film production line 32. The gear pump 73 had a function of increasing pressure at a primary side thereof. The feedback-controlling was performed for the upstream side from the gear pump 73 by an inverter motor, such that the pressure at the primary side became 0.8 MPa, to cause the primary dope 48 to flow. The gear pump 73 had a volumetric efficiency of 99.2%, and degree of fluctuation of discharge rate thereof was at most 0.5%. The casting control section 79 controlled the gear pump 73 such that the gear pump 73 supplied the primary dope 48 to the in-line mixer 75. The primary dope 48 was filtered in the filtration device 74.

In the additive supplying line 78, the liquid of UV-absorbing agent was mixed with the liquid of matting agent, and further stirred by the in-line mixer 75, to obtain an additive mixture. The additive mixture was fed into the pipe 71 by the additive supplying line 78. The primary dope 48 and the additive mixture were mixed together and stirred by the in-line mixer 75 to obtain the casting dope 51.

As the casting device, there was used the casting die 81 which was made by precipitation hardened stainless steel whose volume change was 0.002%. Accuracy of finishing of a contact surface between the casting die 81 and the liquid was at most 1 μm in the surface roughness, and straightness thereof was at most 1 μm/m in any direction. For the purpose of adjusting the temperature of the casting dope 51 at around 34° C., a jacket (not shown) was provided in the casting die 81 and the temperature of the heat transfer medium to be supplied to the jacket was adjusted.

During the film production, the temperature of each of the casting die 81 and the pipe 71 was adjusted at around 34° C. by the temperature controller. The casting die 81 was a coat hunger-type die. The casting die 81 was provided with thickness adjusting bolts at a pitch of 20 mm, and included an automatic thickness adjusting mechanism utilizing heat bolts. As for use of the heat bolts, a profile could be set along a preset program in accordance with an amount of liquid sent with use of the gear pump 73. Additionally, the adjustment amount of the heat bolts could be feedback-controlled along an adjustment program on the basis of a profile of an infrared thickness gauge (not shown) disposed in the film production line 32. A thickness difference between any two points (separate from each other by 50 mm), which were located within an area except a casting edge portion of 20 mm, of the film was regulated to be at most 1 μm. A difference between the largest thickness and the minimum thickness was regulated to be at most 3 μm/m in the width direction. Further, the thickness accuracy was regulated to at most ±1.5%.

The casting process was performed with use of the casting die 81 such that the dried film had a width in the range of 1600 m to 2500 m and a thickness TH1 of 60 μm.

The decompression chamber 90 used for decompression was disposed at the primary side of the casting die 81. The decompression degree of the decompression chamber 90 was adjusted such that the pressure difference between the casting bead in the upstream side from the casting die and the casting bead in the downstream side from the casting die was in the range of 1 Pa to 5000 Pa. The adjustment thereof was performed in accordance with the casting speed. At this time, the pressure difference between the casting bead in the upstream side from the casting die and the casting bead in the downstream side from the casting die was set such that the length of the casting bead was in the range of 20 mm to 50 mm. The decompression chamber 90 was provided with a jacket (not shown) to keep the inside of the decompression chamber 90 at a predetermined temperature. The heat transfer medium adjusted at the temperature of around 35° C. was supplied to the inside of the jacket. Further, the decompression chamber 90 was provided with a mechanism capable of setting the temperature of the decompression chamber 90 higher than the condensation temperature of the gas at the vicinity of the casting portion. At the discharge port of the casting die 81, a labyrinth packing (not shown) was provided for the casting bead in the upstream side from the casting die and the casting bead in the downstream side from the casting die, respectively.

The material for the casting die 81 was precipitation hardened stainless steel. A coefficient of thermal expansion thereof was 2×10⁻⁵ (C⁻¹) or less. The material had resistance to corrosion substantially equivalent to that of SUS316 subjected to a compulsory corrosion examination using an electrolyte aqueous solution. Further, the material had resistance to corrosion such that pitting was not caused on a gas-liquid interface after being soaked in a mixed liquid of dichloromethane, methanol, and water for three months. Accuracy of finishing of a contact surface between the casting die 81 and the liquid was at most 1 μm in the surface roughness, and straightness thereof was at most 1 μm/m in any direction. Slit clearance was adjusted at 1.5 mm. With respect to a corner portion of a lip edge of the casting die 81, which contacted with liquid, a chamfered radius R thereof was adapted to be at most 50 μm in the entire width. Shearing speed for the casting dope 51 inside the casting die 81 was adjusted in the range of 1 to 5000 (1/sec). A hardened film was formed on the lip edge of the casting die 81 by performing WC coating with use of a thermal spraying method.

A stainless cylinder having a width of 3.0 m was used as the casting drum 82 as the support. The peripheral surface 82b of the casting drum 82 was ground such that the surface roughness became at most 0.05 μm. The casting drum 82 was made of SUS316 so as to have sufficient resistance to corrosion and strength. Moreover, unevenness in thickness of the casting drum 82 in the radial direction was at most 0.5%. The casting control section 79 causes the casting drum 82 to rotate by the driving of the axis 82a. The moving speed of the peripheral surface 82b in the moving direction Z1 was set within the range of 50 m/min to 200 m/min. At this time, the speed fluctuation of the peripheral surface 82b was at most 0.5%, and meandering of the casting drum 82 in the width direction caused by one rotation was suppressed within 1.5 mm by detecting positions of side ends of the casting drum 82. Further, vertical position variation between the end of the die lip and the peripheral surface 82b just below the casting die 81 was at most 200 μm. The casting drum 82 was disposed in the casting chamber 62 provided with an air pressure controller (not shown).

The casting drum 82 was configured such that the heat transfer medium could be supplied to the inside of the casting drum 82 in order to control the temperature of the peripheral surface 82b. The heat transfer medium circulator 89 supplied the heat transfer medium at the temperature of not less than −10° C. and not more than 10° C. to the casting drum 82. The surface temperature of the center part of the casting drum 82 just before the casting was 0° C., and the difference in temperature between the side ends thereof was at most 6° C. Note that the casting drum 82 preferably has no surface defect. There were no pin holes having a diameter of 30 μm or more, at most one pin hole having a diameter in the range of 10 μm to 30 μm per square meter, and at most two pin holes having a diameter of less than 10 μm per square meter.

The oxygen concentration under the dry atmosphere on the casting drum 82 was kept at 5 vol %. Note that in order to keep the oxygen concentration at 5 vol %, air was substituted by nitrogen gas. Moreover, in order to condense and recover the solvent in the casting chamber 62, the condenser 87 was disposed therein and the outlet temperature of the condenser 87 was set to −3° C. The static pressure fluctuation at the vicinity of the casting die 81 was reduced to at most ±1 Pa.

The casting dope 51 was cast through the casting die 81 onto the peripheral surface 82b to form the casting film 53 thereon. The casting film 53 was cooled and hardened or solidified on the surface 82b, and then peeled from the casting drum 82 by the peeling roller 83 to form the primary wet film 55. The peeling speed (peel roller draw) was appropriately regulated within the range of 100.1% to 110% relative to the moving speed of the casting drum 82 in order to prevent peeling defect. The liquid compound, having evaporated in the casting chamber 62, was condensed and liquidized by the condenser 87 set at approximately −3° C. to be recovered by the recovery device 88. The recovered solvent was adjusted such that the water content thereof was at most 0.5%. The dry gas from which the solvent was removed was heated again and reused as the dry gas.

The primary wet film 55 was transferred to the transfer section 63 by the peeling roller 83, and then guided to the pin tenter 64 by the rollers 121a to 121c disposed in the transfer section 63. In the transfer section 63, the dry gas at the temperature of approximately 60° C. was applied to the primary wet film 55.

The primary wet film 55 transferred to the pin tenter 64 sequentially passed through each section disposed in the pin tenter 64 while the side ends thereof were held by the pins. During the transportation in the pin tenter 64, the primary wet film 55 was subjected to a predetermined drying process. The temperature of the dry gas in the pin tenter 64 was adjusted so as to be approximately 120° C. Thereafter, the primary wet film 55 was sent to the slitting device 65.

The solvent vapor in the pin tenter 64 was condensed and liquidized at the temperature of −3° C. to be recovered by the condenser for condensation and recovery. The condensed solvent was adjusted such that the water content thereof became as most 0.5 wt %, to be reused.

The slitting device 65 was provided with a NT-type cutter. The slitting device 65 was disposed in a portion to which it took 30 seconds or less from the outlet of the pin tenter 64. The slitting device 65 cut off the primary wet film 55 at a portion 50 mm away from each of the side ends of the primary wet film 55 toward the inward with use of the NT-type cutter. Further, the both side ends of the primary wet film 55 thus cut off were sent to the crusher 95 by a cutter blower (not shown) to be crushed into chips each of which was approximately 80 mm² on average. The chips were reused as the material for preparing the dope together with the TAC flakes.

The primary wet film 55 was sent from the slitting device 65 to the first drying chamber 66. The residual amount of the solvent contained in the primary wet film 55 sent from the slitting device 65 was approximately 10 wt %. In the first drying chamber 66, the wet gas 400 was applied to the primary wet film 55. The primary wet film 55 was subjected to the first drying process 58 for a predetermined period of time SP1 to form the secondary wet film 57. Thereafter, the secondary wet film 57 was sent to the second drying chamber 67.

The wet gas supplying device 125 recovered gas from the first drying chamber 66 as recovered gas 300, and supplied new wet gas 400 to the first drying chamber 66, to keep atmosphere condition in the first drying chamber 66 at a constant level. Water was used as the soft water 410, and air was used as the air 420. The temperature DT1 of the wet gas 400 was approximately 120° C., and the amount of water vapor VM1 contained in the wet gas 400 was 550 g/m³. In this embodiment, the time SP1 was 7 minutes.

In the second drying chamber 67, the dry gas at the temperature of approximately 140° C. was applied to the secondary wet film 57. The secondary wet film 57 was subjected to the second drying process 60 for a predetermined period of time SP2 to form the film 59.

The transporting tension of 100 N/m was applied to the film 59 by the rollers disposed in the second drying chamber 67. The secondary wet film 57 was dried for approximately 5 minutes until the residual amount of the solvent contained in the secondary wet film 57 finally became 0.3 wt %. The lap angle of the film 59 with respect to the rollers was within the range of 80 degrees and 190 degrees. The material of the rollers was aluminum or carbon steel. The surface of each of the rollers was subjected to hard chrome-plating, and one surface thereof was flat, and the other surface thereof was dimpled. The fluctuation of all the film positions due to the rotation of the rollers was at most 50 μm. Note that deflection of the rollers at the transporting tension of 100N/m was regulated to at most 0.5 mm.

The solvent vapor contained in the dry gas was adsorbed and recovered by the adsorption and recovery device 101 to be removed. The adsorption and recovery were performed by using activated carbon for adsorption and dry nitrogen for desorption. The recovered solvent was adjusted such that the water content thereof became at most 0.3 wt % or less to be reused as the solvent for preparing the dope. The dry gas included substances of high boiling point such as plasticizer, UV-absorbing agent, and the like, in addition to the solvent vapor. Therefore, the substances were cooled by the cooler and removed by preadsorber to be circulated and reused. The adsorbing and desorbing conditions were set such that VOC (volatile organic compound) contained in the gas exhausted outside became at most 10 ppm at the final stage. The amount of the solvent to be recovered by the condensation method relative to all the solvent vapor was 90 wt %, and most remaining solvent was recovered by performing the adsorption and desorption.

The dried film 59 was transported to the first humidity control chamber (not shown). The dry gas at a temperature of 110° C. was applied to the transfer section between the second drying chamber 67 and the first humidity control chamber. The air at a temperature of 50° C. and at a dew point of 20° C. was supplied to the first humidity control chamber. Further, the film 59 was transported to the second humidity control chamber (not shown) for preventing curling of the film 59. In the second humidity control chamber, air at a temperature of 90° C. and at a humidity of 70% was applied to the film 59.

The film 59 after the humidity control was fed into the cooling chamber 68 to be cooled until the temperature thereof became 30° C. or less. Then, the side ends of the film 59 were cut again by the slitting device (not shown). The compulsory neutralization device 104 was provided such that the voltage applied to the film 59 during transportation was always kept within the range of −3 kV to 3 kV. Additionally, the knurling was formed on the both side ends of the film 59 by the knurling roller 105. Note that the knurling was formed by performing emboss processing starting from one end of the film 59 to the other end thereof. In this case, the width subjected to the knurling was 10 mm, and pressure applied by the knurling roller 105 was set such that a height of the evenness was higher than the average thickness of the film 59 by 12 μm on average.

Then, the film 59 was transported to the winding chamber 69. Inside the winding chamber 69, the room temperature was kept at 28° C. and the humidity was kept at 70%. Additionally, a neutralization device utilizing ionic wind (not shown) was disposed in the winding chamber 69 to regulate the voltage applied to the film 59 to not less than −1.5 kV and not more than 1.5 kv. Finally, the film 59 was wound by the winding roller 107 disposed in the winding chamber 69 while tension at a desired level was applied to the film 59 by the press roller 108.

### Example 2

The film 59 was formed under the same conditions as those in Example 1 except that the amount of water vapor VM1 contained in the wet gas 400 was set to 500 (g/m³).

### Example 3

The film 59 was formed under the same conditions as those in Example 1 except that the amount of water vapor VM1 contained in the wet gas 400 was set to 400 (g/m³).

### Example 4

The film 59 was formed under the same conditions as those in Example 1 except that the amount of water vapor VM1 contained in the wet gas 400 was set to 300 (g/m³).

### Comparative Example 1

The film was formed under the same conditions as those in Example 1 except that dry air containing no water vapor was used instead of the wet gas 400 in the first drying chamber 66. Note that the temperature of the dry air in the first drying chamber 66 was set to 120° C., and the drying process was performed in the first drying chamber 66 for 7 minutes.

### Example 5

The film 59 was formed under the same conditions as those in Example 1 except that the casting process 54 was performed such that the thickness TH1 of the film 59 became 80 μm and the temperature DT1 of the wet gas 400 was set to approximately 140° C.

### Example 6

The film 59 was formed under the same conditions as those in Example 5 except that the amount of water vapor VM1 contained in the wet gas 400 was set to 500 (g/m³).

### Example 7

The film 59 was formed under the same conditions as those in Example 5 except that the amount of water vapor VM1 contained in the wet gas 400 was set to 400 (g/m³).

### Example 8

The film 59 was formed under the same conditions as those in Example 5 except that the amount of water vapor VM1 contained in the wet gas 400 was set to 300 (g/m³).

### Comparative Example 2

The film was formed under the same conditions as those in Example 5 except that dry air containing no water vapor was used instead of the wet gas 400 in the first drying chamber 66. Note that the temperature of the dry air in the first drying chamber 66 was set to 120° C., and the drying process was performed in the first drying chamber 66 for 7 minutes.

### Comparative Example 3

The film was formed under the same conditions as those in Example 6 except that the casting process 54 was performed such that the thickness TH1 of the film became 10 μm.

### Comparative Example 4

The film was formed under the same conditions as those in Comparative Example 2 except that the casting process 54 was performed such that the thickness TH1 of the film became 10 μm.

### Comparative Example 5

The film was formed under the same conditions as those in Comparative Example 2 except that the drying process was performed in the first drying chamber 66 for 15 minutes.

### Example 9

The film 59 was formed under the same conditions as those in Example 1 except that the wet gas supplying device 125 was substituted with the wet gas supplying device 240, water was substituted with methanol, and the amount of methanol (VM1) contained in the wet gas 402 was 900 g/m³.

### Example 10

The film 59 was formed under the same conditions as those in Example 9 except that methanol was substituted with acetone, and the amount of acetone (VM1) contained in the wet film 402 was 1800 g/m³.

[Evaluation of the Film]

In the above experiments, the residual amount of solvent and water content in the secondary wet film 57 sent from the first drying chamber 66 were measured. Note that the measurement below was common among all the above Examples and Comparative Examples. The evaluation results of each example are shown in Table 1. Note that the reference numerals in the evaluation results shown in Table 1 correspond to the reference numerals for each evaluation items below.

1. Measurement of Residual Amount of Solvent

A film strip having a size of 7 mm×35 mm was cut out from the film obtained in Examples and Comparative Examples as a measuring sample. The residual amount of solvent in the measuring sample was measured with use of a residual solvent vaporizing device produced by Teledyne Technologies Company (Teledyne Tekmar) and a gas chromatography produced by GL Sciences Inc.

2. Measurement of Water Content

A film strip having a size of 7 mm×35 mm was cut out from the film obtained in Examples and Comparative Examples as a measuring sample. The mass of water was measured by Karl Fischer's method with use of a water vaporizing device and a water measurement device produced by Metrohm-Shibata Co., Ltd. The water content was obtained by dividing the measured mass of the water by mass (g) of the measuring sample.

According to the first drying process 58 and the second drying process 60 with use of the wet gas 400, it was fount that the liquid compound can be eliminated more efficiently in comparison with a conventional drying process. Additionally, it was found that the liquid compound can be eliminated more readily as the amount of the water vapor VM1 contained in the wet gas 400 is increased. Moreover, since the water content in the film subjected to the first and second drying processes 58 and 60 was approximately equivalent to that subjected to only the second drying process 60, it was found that the first drying process 58 does not cause new defects that small-volume compounds remain in the film 59. Further, the effect of the present invention is achieved prominently in the case where the thickness of the film at the time of starting the first drying process 58 is a predetermined level or more. Accordingly, according to the present invention, it is possible to form a thick film efficiently.

TABLE 1

| | small- | | | | | Evaluation | |
|---|---|---|---|---|---|---|---|
| | volume | TH1 | DT1 | SP1 | VM1 | result | |
| | compound | (μm) | (° C.) | (min) | (g/m³) | 1(wt %) | 2(wt %) |
| Ex 1 | water | 60 | 120 | 7 | 550 | 0.35 | 1.5 |
| Ex 2 | water | 60 | 120 | 7 | 500 | 0.41 | 1.4 |
| Ex 3 | water | 60 | 120 | 7 | 400 | 0.53 | 1.4 |
| Ex 4 | water | 60 | 120 | 7 | 300 | 0.78 | 1.3 |
| Com 1 | — | 60 | — | — | — | 1.0 | 1.3 |
| Ex 5 | water | 80 | 140 | 7 | 550 | 0.45 | 1.5 |
| Ex 6 | water | 80 | 140 | 7 | 500 | 0.51 | 1.5 |
| Ex 7 | water | 80 | 140 | 7 | 400 | 0.69 | 1.4 |
| Ex 8 | water | 80 | 140 | 7 | 300 | 0.91 | 1.4 |
| Com 2 | — | 80 | — | — | — | 1.2 | 1.3 |
| Com 3 | water | 10 | 140 | 7 | 500 | 0.21 | 1.5 |
| Com 4 | — | 10 | — | — | — | 0.21 | 1.4 |
| Com 5 | — | 80 | — | — | — | 0.60 | 1.6 |
| Ex 9 | methanol | 60 | 120 | 7 | 900 | 0.80 | 1.3 |
| Ex 10 | acetone | 60 | 120 | 7 | 1800 | 0.90 | 1.3 |

The present invention is not to be limited to the above embodiments, and on the contrary, various modifications will be possible without departing from the scope and spirit of the present invention as specified in claims appended hereto.

1. A solution casting method comprising the steps of:
casting a dope containing a polymer and a solvent onto a support to form a casting film;
hardening said casting film on said support;
peeling said casting film from said support to form a wet film; and
drying said wet film in dry gas to form a film, said dry gas containing a small-volume compound having molar volume smaller than that of a liquid compound constituting said solvent.

2. A solution casting method as defined in claim 1, wherein said solvent consists of plural compounds, and among said plural compounds, a compound having the smallest molar volume is said liquid compound.

3. A solution casting method as defined in claim 2, wherein said dry gas contains said small-volume compound in the range of 0.3 MS to 1.0 MS, MS being an amount of saturated vapor of said small-volume compound in said dry gas.

4. A solution casting method as defined in claim 3, wherein a temperature of said dry gas is at least a boiling point (° C.) of said small-volume compound and at most three times said boiling point (° C.).

5. A solution casting method as defined in claim 4, wherein said liquid compound contains at least one of dichloromethane, methanol, ethanol, and butanol, and said small-volume compound contains at least one of water, methanol, acetone, and methyl ethyl ketone.

6. A solution casting method as defined in claim 5, wherein the drying is applied to said wet film after drying by a tenter dryer.

7. A solution casting method defined in claim 6, wherein heated gas is applied to said wet film after the drying.

8. A solution casting apparatus comprising:
a support onto which a dope containing a polymer and a solvent is cast to form a casting film thereon; and
a drying device for drying a wet film in dry gas to form a film, said dry gas containing a small-volume compound having molar volume smaller than that of a liquid compound constituting said solvent, and said wet film being said casting film peeled from said support.

9. A solution casting apparatus as defined in claim 8, wherein
said drying device comprising:
plural rollers for transporting said wet film, said wet film being bridged over said rollers;
a drying chamber for housing said plural rollers; and
a dry gas supplying unit for circulating said dry gas in said drying chamber.

10. A solution casting apparatus as defined in claim 9 further comprising a tenter dryer disposed in an upstream side from said drying device in a transporting direction of said wet film, said tenter dryer holding side ends of said wet film and transporting said wet film while applying dry gas thereto.

11. A solution casting apparatus as defined in claim 10 further comprising a dryer using heated air disposed in a downstream side from said drying device in the transporting direction of said wet film, said dryer using heated air applying heated gas to said wet film transported from said drying device.
